(19) United States
(12) Patent Application Publication
(10) Pub. No.: US 2026/0254083 A1
(43) Pub. Date: Aug. 27, 2026

(54) CIRCUITS AND METHODS FOR HIGH FREQUENCY FILTERS

(71) Applicant: Murata Manufacturing Co., Ltd., Nagaokakyo-shi, Kyoto (JP)

(72) Inventor: William Richard SMITH, Jr., San Diego, CA (US)

(21) Appl. No.: 19/160,226

(22) PCT Filed: Jan. 8, 2024
(86) PCT No.: PCT/US2024/010722

§ 371 Date: Aug. 27, 2025

Related U.S. Application Data
(60) Provisional application No. 63/490,721, filed on Mar. 16, 2023.
(60) Provisional application No. 63/498,430, filed on Apr. 26, 2023.

(51) Int. Cl. H01P 1/203; H01P 7/08

(52) U.S. Cl. CPC H01P 1/20345; H01P 7/08

(57) ABSTRACT

Printed-line filter designs with wide bandwidth, low insertion loss, good stopband attenuation, independent control of low-side and high-side attenuation, and high selectivity. Embodiments include a printed-line pseudo-HPF design with such characteristics, and a printed-line cascaded BPF design which has approximately the same insertion loss as an equivalent single printed-line BPF filter but with greater ultimate stopband attenuation. One embodiment includes a printed interdigitated-line BPF including at least one coupling enhancement strip. Another embodiment includes a cascaded BPF including a low-pass filter and an electrically coupled printed interdigitated-line BPF including at least one coupling enhancement strip. The printed interdigitated-line bandpass filter includes a set of interdigitated resonator sections, each adjacent pair of interdigitated resonator sections being separated by an associated gap, wherein the at least one coupling enhancement strip is spaced from an associated gap separating an adjacent pair of interdigitated resonator sections in the set of interdigitated resonator sections.

### CROSS-REFERENCE TO RELATED APPLICATIONS

The present application claims priority to U.S. Provisional Application No. 63/490,721 filed on Mar. 16, 2023, and U.S. Provisional Application No. 63/498,430 filed on Apr. 26, 2023, the contents of all of which are incorporated herein by reference in their entirety.

### BACKGROUND

### (1) Technical Field

The invention relates to electronic circuits, and more particularly to radio frequency filter circuits.

### (2) Background

Many modern electronic systems include radio frequency (RF) receivers; examples include cellular telephones, personal computers, tablet computers, wireless network components, televisions, cable system “set top” boxes, and radar systems. Many RF receivers are paired with RF transmitters in the form of transceivers, which often are quite complex two-way radios. In some cases, RF transceivers are capable of transmitting and receiving across multiple frequencies in multiple bands. For example, in the United States, the 2.4 GHz band is divided into 14 channels spaced about 6 MHz apart. As another example, a modern “smart telephone” may include RF transceiver circuitry capable of concurrently operating on different cellular and local-area communications systems, on different wireless network frequencies and protocols, and on “personal” area networks (e.g., Bluetooth based systems). Plans are underway globally for a wide variety of potential applications for sixth-generation (6G) wireless RF technologies, including but not limited to extremely wideband telecommunication channels in upper millimeter wave and terahertz frequencies having greatly expanded data capacity.

It is important for radio systems to filter out undesired frequencies and pass only desired frequencies, both from an operational perspective and in order to comply with multiple regulatory criteria. As such, RF filters-particularly bandpass filters-are critical components of radio systems.

FIG. 1 is a graph of RF signal insertion loss as a function of frequency for an idealized single bandpass filter (BPF). The graph line 102 comprises a passband, low-side and high-side transition bands, and low-side and high-side stopbands. The center frequency of the passband is f₀, while the low-side edge and high-side edge of the passband are at frequencies f_{EL} and f_{EH}, respectively. The passband edge frequencies f_{EL} and f_{EH} are generally defined as the frequencies where the insertion loss (IL) is a specified number of decibels (e.g., 0.6 dB, 1 dB, 3 dB, etc.) below the midband f₀.

A low-side attenuation frequency f_{AL} denotes the closest frequency to f₀ at which the low-side stopband must attain a specified attenuation level L_{MAX_L} (e.g., 26 dB). A high-side attenuation frequency f_{AH} denotes the closest frequency at which the high-side stopband must attain a specified attenuation L_{MAX_H}. In this example, L_{MAX_L} equals L_{MAX_H}, but the two values may differ.

The low-side transition band extends from f_{AL} to f_{EL}, while the high-side transition band extends from f_{EH} to f_{AH}. Selectivity for a filter is measured by the required stopband attenuation (L_{MAX_L} or L_{MAX_H}) and the width of the respective transition band (i.e., f_{EL}-f_{AL} or f_{AH}-f_{EH}). Higher selectivity generally requires a higher-order filter (more resonators or reactive elements) with a higher concomitant insertion loss.

A bandpass filter may be implemented either as a single filter (e.g., lumped-LC at low frequencies or using distributed transmission lines at higher frequencies) or as a cascade of a low-pass filter (LPF) and a high-pass filter (HPF). For example, FIG. 2 is a graph of RF signal insertion loss as a function of frequency for an idealized cascaded BPF comprising an LPF serially coupled to (cascaded with) an HPF. As graph line 202 shows, the passbands of the LPF and HPF overlap, forming the passband of a BPF.

FIGS. 1 and 2 are idealized. In practical filter circuits, a passband is generally not perfectly flat, the edges of a passband are generally rounded, there may be a number of zeroes outside the passband, and there may be frequency spans outside the passband where attenuation lessens.

A single BPF is simpler to implement and will typically occupy less space than a cascaded BPF. The most common (all-pole) design methods result in approximately equal selectivities on the low-side and high-side of the passband, satisfying the more stringent (low-side or high-side) requirement of a specification. This results in a slight sacrifice in flexibility of design and in insertion loss being slightly higher than the theoretical minimum for the selectivity requirements. Ultimate stopband attenuation is limited by electromagnetic feedthrough.

Cascaded BPF designs can provide higher ultimate stopband attenuation and automatically provide the flexibility to independently design for different selectivity requirements on the low-side and high-side of the passband. However, the total size of a cascaded BPF will generally be larger than that of a single BPF and the order (number of resonators or reactive elements) generally will be larger in both the LPF and the HPF circuits than the order required in the equivalent single BPF to achieve the same selectivity.

Conventionally, RF filters are fabricated using a variety of technologies, including waveguides, cavities, and printed-line circuits (microstrip and stripline). Waveguides and cavities exhibit robust, low-loss performance and are generally good candidates for communication system base stations, but are generally not competitive with printed-line filter circuits for high-volume handset applications, particularly at frequencies above 100 GHZ, because of cost and size. Accordingly, there is a growing commercial interest in printed-line BPFs.

FIG. 3 is a plan view of the layout of a prior-art sixth-order parallel-coupled printed-line BPF 300. Seven printed-line sections 302a-302g of conductive material (e.g., Al or Cu) are printed onto a substrate (e.g., a printed circuit board, PCB, or a silicon wafer die) in a parallel, spaced-apart, and staggered configuration between a first port P1 and a second port P2. The X and Y dimensions of each section 302a-302g and the spacing between sections 302a-302g may be varied to achieve desired reactance and coupling values, and hence the desired filter response.

FIG. 4 is a plan view of the layout of a prior-art printed interdigitated-line eleventh-order BPF 400. Parallel, spaced-apart resonator sections 402a-402k of conductive material are printed onto a substrate between ports P1 and P2. One end of each section 402a-402k (the end alternates between adjacent sections) is connected by a corresponding via 404 or 406 to both an overlaying conductive ground plane and an underlying conductive ground plane (not shown). The lengths of the sections 402a-402k in the Y direction control the center frequency f₀ of the BPF 400 and generally are about one-quarter of the wavelength of f0. The widths of the sections 402a-402k in the X direction control the internal impedance level of the BPF, the spacings (which need not be uniform) between the sections 402a-402k control the bandwidth of the BPF, and the location in the Y direction of the P1 and P2 port “tap points” control matching to an external system impedance.

FIG. 5A is a schematic diagram of an idealized prior-art ninth-order LPF having lumped reactive elements. Four inductors L1-L4 are coupled in series between a first port P1 and a second port P2. Five capacitors C1-C4 are coupled between a reference potential (e.g., circuit ground) and respective end terminals of the inductors L1-L4, as shown.

FIG. 5B is a plan view of the layout of a prior-art printed-line stepped-impedance ninth-order LPF 500. Alternating wide sections 502a-502e and narrow line sections 504a-504d of conductive material printed onto a substrate between ports P1 and P2 emulate the capacitors and inductors of the circuit shown in FIG. 5A. The X and Y dimensions of each section may be varied to achieve desired reactance values.

FIG. 5C is a plan view of the layout of a prior-art printed commensurate-line ninth-order LPF. Equal-length “commensurate” lines 522a-522e between ports P1 and P2 and inter-line eighth-wave shunt stubs 524a-524d of conductive material printed onto a substrate emulate the capacitors and inductors of the circuit shown in FIG. 5A. The X and Y dimensions of each section may be varied to achieve desired filter performance.

Minimizing filter IL within the passband at all frequencies is important, particularly for receiver front-end filters. Minimizing filter IL is especially problematic when implementing printed-line filters at high frequencies (e.g., at or above 100 GHz) because the skin-depth of current flowing through the printed-line sections is on the order of 0.1 μm, resulting in high ohmic losses and relatively low resonator Q. In addition to inherent component loss mechanisms (finite Q of L's and C's or conduction losses in metals and dielectric losses in insulating substrates for printed-line filters), the design parameter requirements of a BPF also influence the filter IL. Specifically, the IL is inversely proportional to fractional bandwidth (the ratio of filter bandwidth to center frequency f₀) and also increases with increasing selectivity (higher required stopband attenuation and narrower transition band width relative to passband width). In general, transition bandwidths, fractional passband width for BPFs, and passband edge cutoff frequencies for low-pass and high-pass filters are specified as design/performance requirements and thus are not available as design variables for reducing IL. Accordingly, other design parameter values and materials must be selected to minimize IL.

The present invention addresses a need not fulfilled by conventional printed-line filter designs, particularly at high frequencies: bandpass filters with wide bandwidth, low insertion loss, sufficient levels of stopband attenuation, independent control of attenuation within low-side and high-side frequency ranges, and high selectivity.

### SUMMARY

The present invention encompasses printed-line filter designs having wide bandwidth, low insertion loss, sufficient levels of stopband attenuation, independent control of attenuation within low-side and high-side frequency ranges, and high selectivity. Embodiments include novel printed-line pseudo-HPF designs with such characteristics, and a novel printed-line cascaded BPF design incorporating one of the novel pseudo-HPF designs and which has approximately the same insertion loss as an equivalent single printed-line BPF filter but with greater ultimate stopband attenuation.

In broad terms, one aspect of the present invention includes a bandpass filter including a printed interdigitated-line bandpass filter including at least one coupling enhancement strip. Another aspect of the present invention includes a cascaded bandpass filter including a low-pass filter, and a printed interdigitated-line bandpass filter including at least one coupling enhancement strip and electrically coupled to the low-pass filter. In both embodiments, the printed interdigitated-line bandpass filter includes a set of interdigitated resonator sections, each adjacent pair of interdigitated resonator sections being separated by an associated gap, wherein the at least one coupling enhancement strip is spaced from an associated gap separating an adjacent pair of interdigitated resonator sections in the set of interdigitated resonator sections.

A variety of alternative coupling enhancement strips provide design flexibility to adjust cross-coupling of input RF signals between input and output ports of a printed-line cascaded BPF in order to enhance the presence and location of a low-side zero, which may aid in selectivity.

The details of one or more embodiments of the invention are set forth in the accompanying drawings and the description below. Other features, objects, and advantages of the invention should be apparent from the description and drawings, and from the claims.

### DESCRIPTION OF THE DRAWINGS

FIG. 1 is a graph of RF signal insertion loss as a function of frequency for an idealized single bandpass filter (BPF).

FIG. 2 is a graph of RF signal insertion loss as a function of frequency for an idealized cascaded BPF comprising an LPF serially coupled to (cascaded with) an HPF.

FIG. 3 is a plan view of the layout of a prior-art sixth-order parallel-coupled printed-line BPF.

FIG. 4 is a plan view of the layout of a prior-art printed interdigitated-line eleventh-order BPF.

FIG. 5A is a schematic diagram of an idealized prior-art ninth-order LPF having lumped reactive elements.

FIG. 5B is a plan view of the layout of a prior-art printed-line stepped-impedance ninth-order LPF.

FIG. 5C is a plan view of the layout of a prior-art printed commensurate-line ninth-order LPF.

FIG. 6 is a graph of RF signal insertion loss as a function of frequency for three different modeled LPF designs.

FIG. 7A is a first plan view of the layout of an improved printed interdigitated-line eleventh-order pseudo-HPF showing two underlying coupling enhancement strips in phantom outline.

FIG. 7B is a second plan view of the layout of the pseudo-HPF of FIGS. 7A and 7B showing two overlying coupling enhancement strips.

FIG. 7C is a cross-sectional view of the pseudo-HPF of FIG. 7A, taken along line A-A.

FIG. 8 is a cross-sectional view of an improved printed interdigitated-line eleventh-order pseudo-HPF that includes added CES's.

FIG. 9 is a graph of RF signal insertion loss as a function of frequency for a model of the pseudo-HPF of FIG. 7C.

FIG. 10 is a block diagram of an improved BPF comprising a printed-line LPF and a pseudo-HPF.

FIG. 11A is a graph of RF signal insertion loss as a function of frequency for two different modeled BPF designs, one being a single BPF and one being a cascaded BPF.

FIG. 11B is an enlarged portion of the graph of FIG. 11A.

FIG. 12 is a plan view of the layout of a first variant pseudo-HPF.

FIG. 25 is a plan view of the layout of a second variant pseudo-HPF.

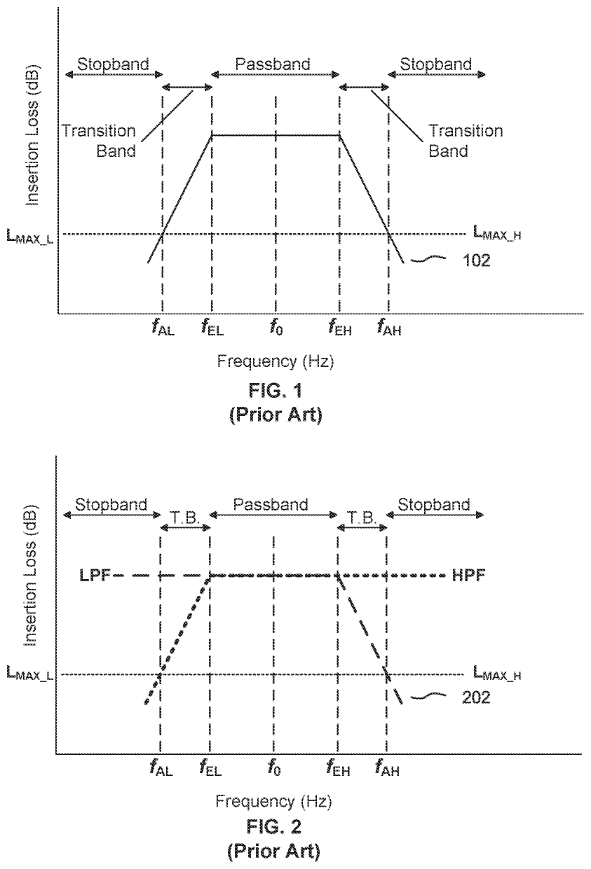

FIG. 14 is a plan view of the layout of a third variant pseudo-HPF.

FIG. 15 is a plan view of the layout of a fourth variant pseudo-HPF.

FIG. 16 is a plan view of the layout of a fifth variant pseudo-HPF.

FIG. 17 is a plan view of the layout of a sixth variant pseudo-HPF.

FIG. 18 is a cross-sectional view of a variant pseudo-HPF based on the pseudo-HPF 700 of 7C.

FIG. 19 is a plan view of the layout of a seventh variant pseudo-HPF.

FIG. 20 is a variant of the embodiment pseudo-HPF shown in FIG. 19 in which the coupling strip TL has horizontal (with respect to the page) meandering sections.

FIG. 21 is a plan view of the layout of an eighth variant pseudo-HPF.

FIG. 22 is a plan view of the layout of a ninth variant pseudo-HPF.

FIG. 23A is a graph of RF signal insertion loss as a function of frequency for a model of the pseudo-HPF of FIG. 22 coupled to various values of capacitance within the impedance network.

FIG. 23B is a graph of RF signal insertion loss as a function of frequency for two modeled cascaded BPFs utilizing the pseudo-HPF of FIG. 22.

FIG. 24 is a top plan view of a substrate that may be, for example, a printed circuit board or chip module substrate (e.g., a thin-film tile).

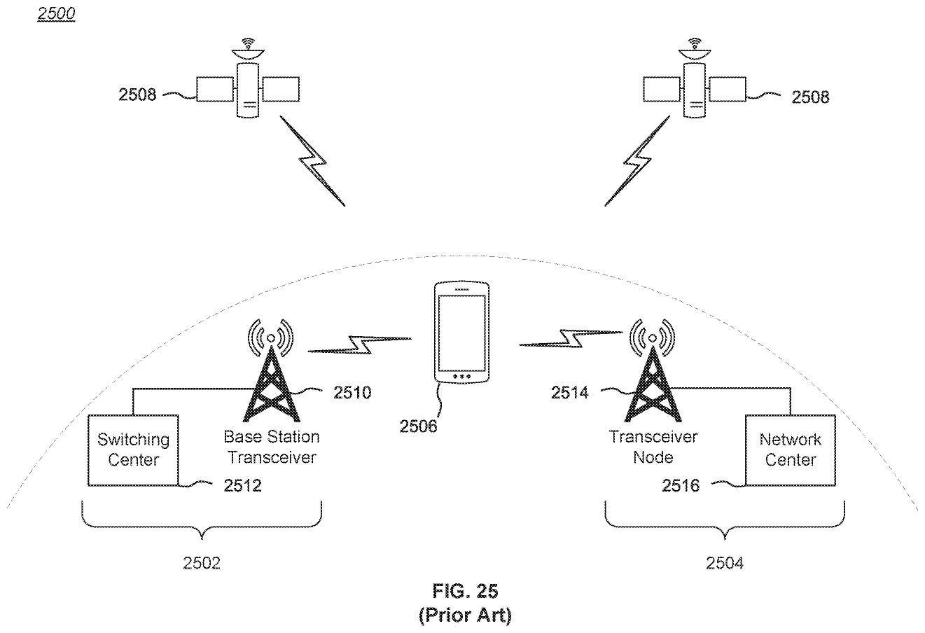

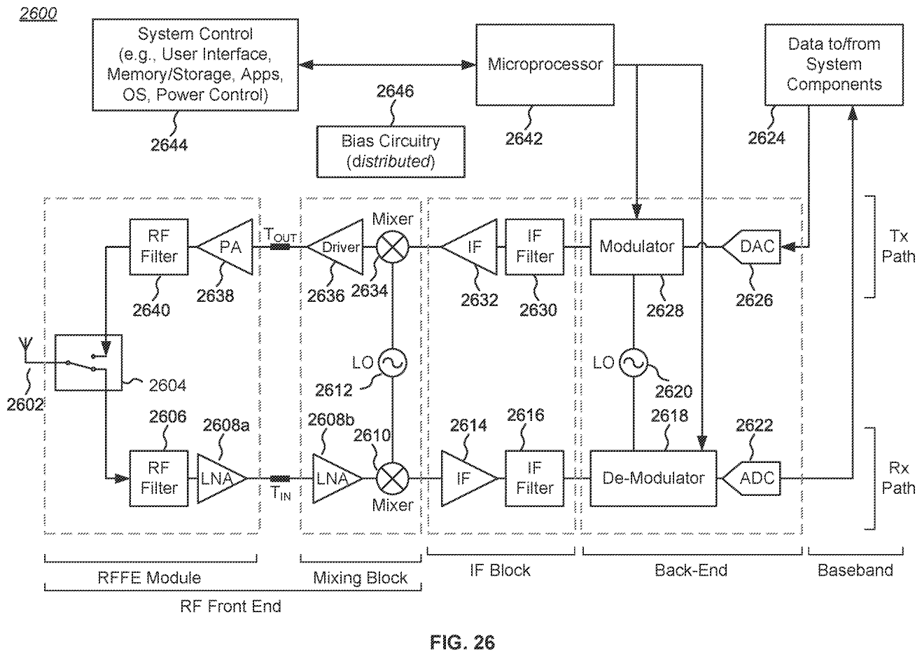

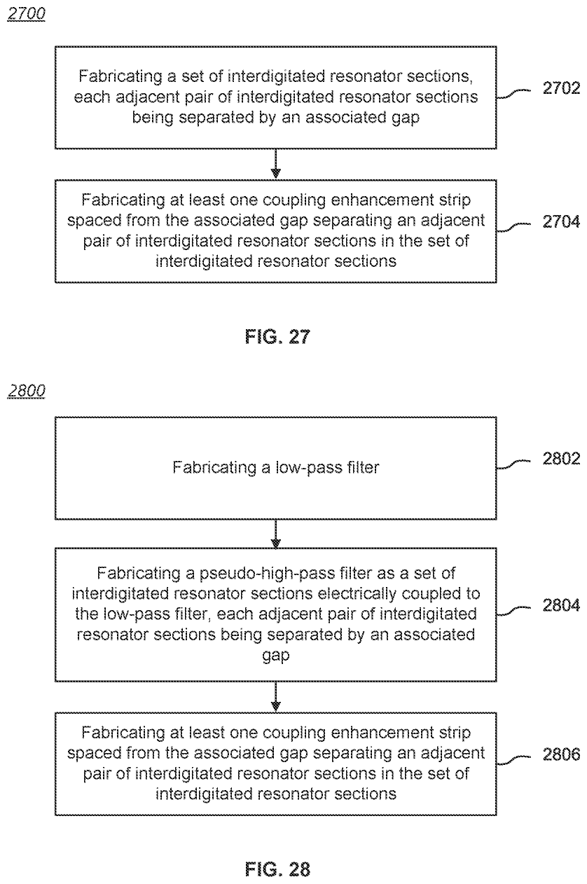

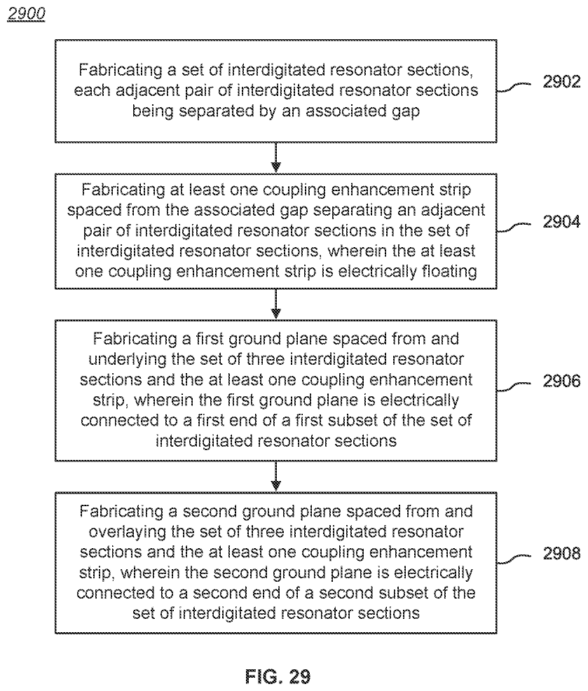

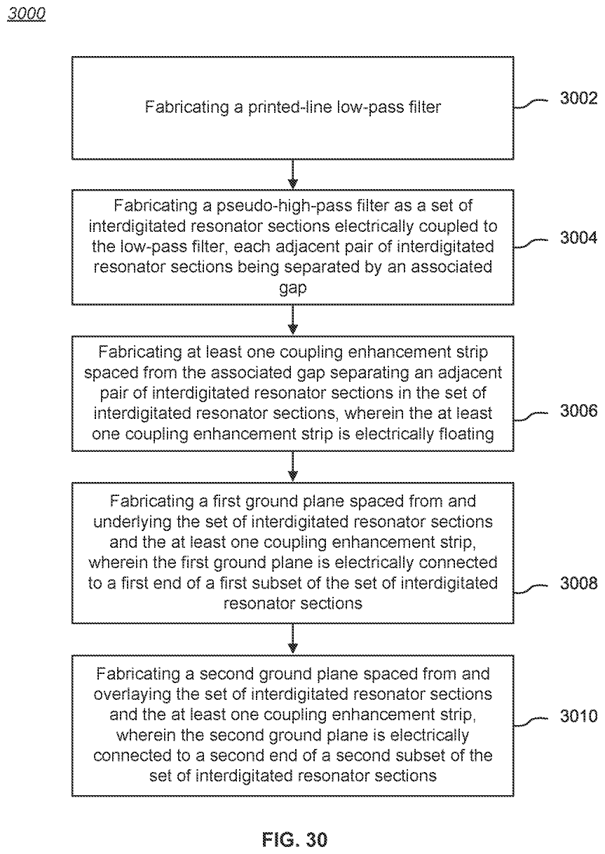

FIG. 25 illustrates a prior art wireless communication environment comprising different wireless communication systems, which may include one or more mobile wireless devices.

FIG. 26 is a block diagram of a transceiver that might be used in a wireless device, such as a cellular telephone, and which may beneficially incorporate an embodiment of the present invention for improved performance.

FIG. 27 is a process flow chart showing a method for making a printed interdigitated-line wideband BPF.

FIG. 28 is a process flow chart showing a method for making a printed-line wideband cascaded BPF.

FIG. 29 is a process flow chart showing a first method for making a printed interdigitated-line wideband BPF approaching a high-pass filter (i.e., a pseudo-high-pass filter).

FIG. 30 is a process flow chart showing a second method for making a printed-line cascaded wideband BPF.

Like reference numbers and designations in the various drawings indicate like elements unless the context requires otherwise.

### DETAILED DESCRIPTION

The present invention encompasses printed-line filter designs having wide bandwidth, low insertion loss, sufficient levels of stopband attenuation, independent control of attenuation within low-side and high-side frequency ranges, and high selectivity. Embodiments include novel printed-line pseudo-HPF designs with such characteristics, and a novel printed-line cascaded BPF design incorporating one of the novel pseudo-HPF designs and which has approximately the same insertion loss as an equivalent single printed-line BPF filter but with greater ultimate stopband attenuation.

### Preferred LPF Design for a Printed-Line Cascaded BPF

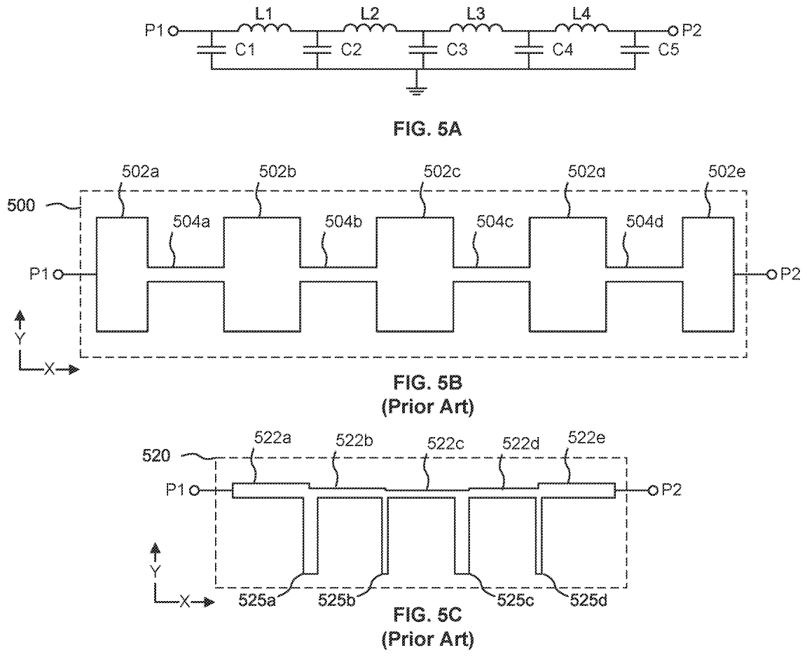

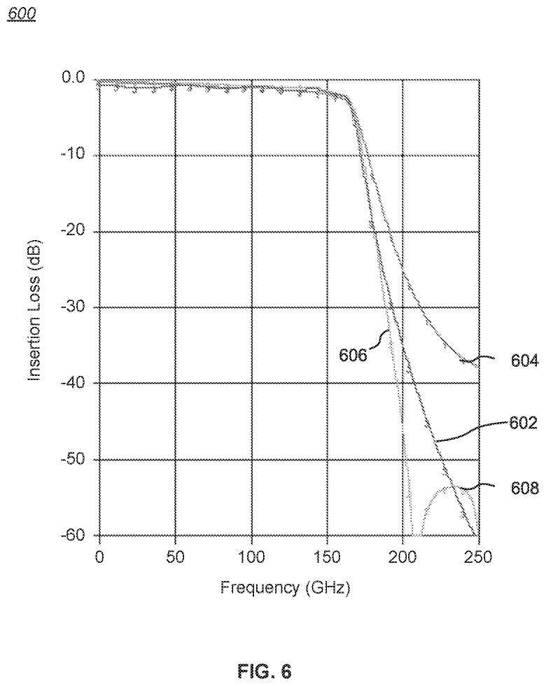

The novel cascaded BPF design of the present invention preferably includes a printed-line LPF with high selectivity. FIG. 6 is a graph 600 of RF signal insertion loss as a function of frequency for three different modeled LPF designs. Graph line 602 is generated by a modeled version of the ideal lumped LC LPF of FIG. 5A (noting that lumped-LC filters are practical only up to a few GHz at most; however, simulated performance of filters with idealized LC elements serves as a useful reference point for higher-frequency filters implemented with printed-line resonators). Graph line 604 is generated by a modeled version of the printed-line stepped-impedance LPF of FIG. 5B. Graph line 606 is generated by a modeled version of the printed-line commensurate-line LPF of FIG. 5C.

The stepped-impedance LPF, while relatively simple to design, has a slower cutoff (wider transition band) than the equivalent ideal lumped LC LPF, while the commensurate-line LPF has a faster cutoff (narrower transition band) than the equivalent ideal lumped LC LPF. Thus, the commensurate-line LPF (graph line 606) can often provide a higher selectivity, meaning that a commensurate-line LPF with a slightly lower order filter may be used to achieve the same selectivity as a higher order stepped-impedance LPF, resulting in a lower passband IL. If the (spurious) harmonic passbands (graph line portion 608) of the commensurate-line LPF are acceptable for a particular application, a commensurate-line LPF generally will be the better option for minimizing IL when coupled to the novel HPF of the present invention to form an improved cascaded BPF.

Accordingly, a preferred LPF design for the cascaded BPF of the present invention is a printed commensurate-line architecture. However, it should be understood that in some applications, other LPF designs may be used in conjunction with the novel pseudo-HPF of the present invention to form an improved cascaded BPF. Such other LPF designs include (without limitation) a lumped-element LPF (useful at lower frequencies, such as below 10 GHz), a printed-line stepped-impedance LPF, and other printed-line LPFs.

Pseudo-HPF Architecture A printed interdigitated-line BPF can provide a wide bandwidth because of relatively strong coupling between adjacent resonator sections. The strongest couplings occur between the first pair and the last pair of resonator sections. Notably, the bandpass characteristics of a printed interdigitated-line BPF can be modified to behave more like an “pseudo-HPF” having a very wide bandwidth, strong out-of-passband attenuation, good selectivity for low-side frequencies, and only a very slow roll-off of the high-side transition-band to a very shallow stopband. Since strong adjacent-resonator couplings and wide bandwidth are also associated with reduction of IL, a pseudo-HPF is particularly suitable for coupling to an LPF to form a cascaded BPF appropriate for meeting most bandwidth specifications.

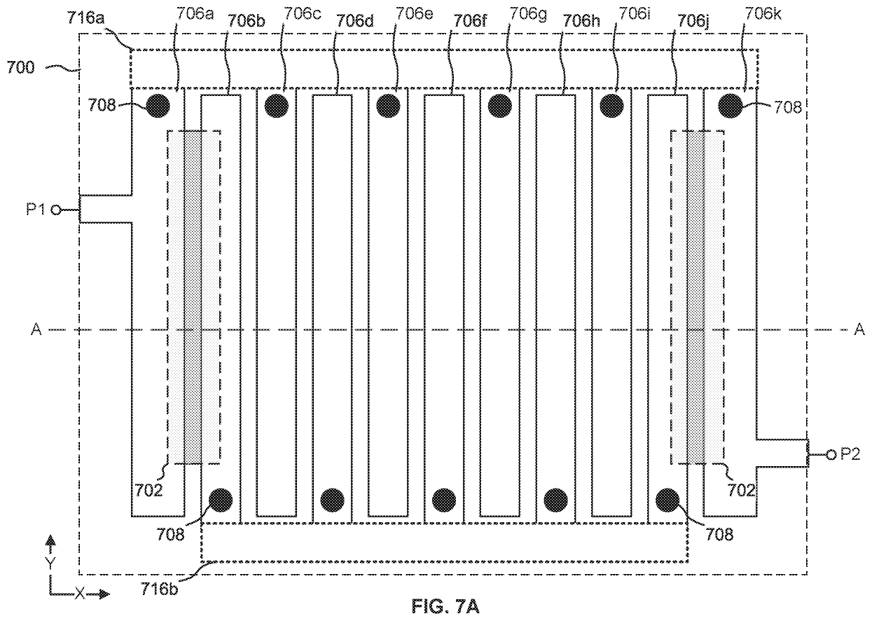

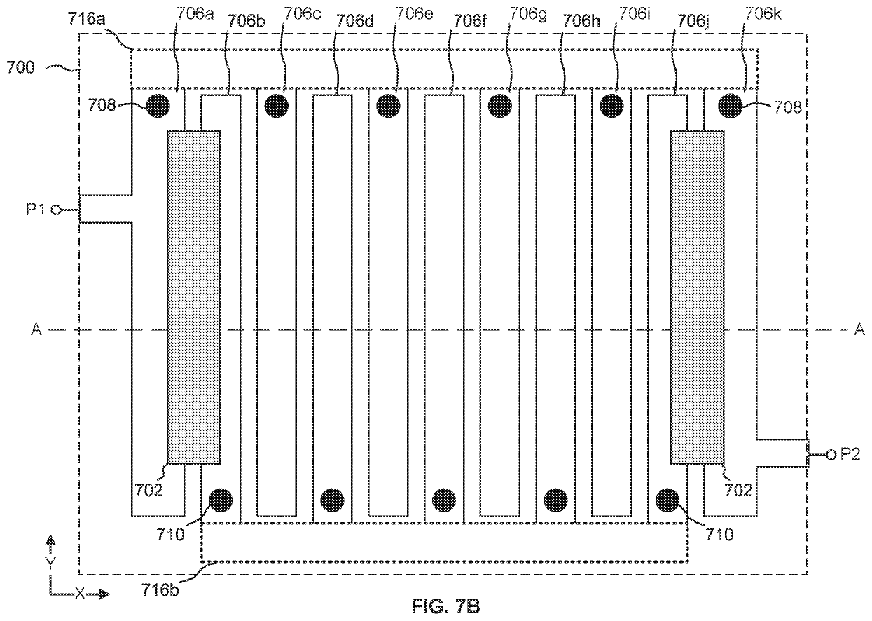

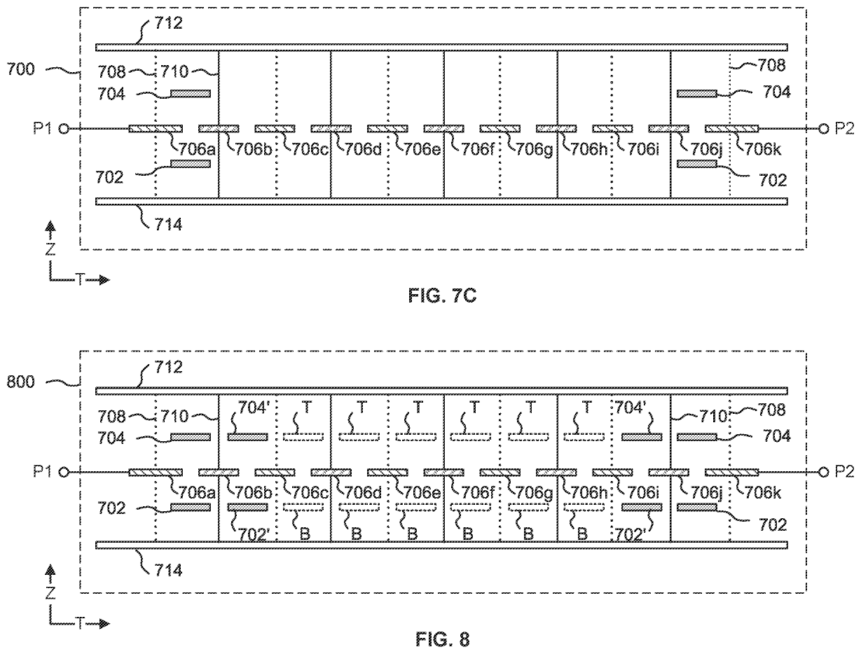

FIG. 7A is a first plan view of the layout of an improved printed interdigitated-line eleventh-order pseudo-HPF 700 showing two underlying coupling enhancement strips 702 in phantom outline. FIG. 7B is a second plan view of the layout of the pseudo-HPF 700 of FIG. 7A showing two overlying coupling enhancement strips 704. 7C is a cross-sectional view of the pseudo-HPF 700 of FIGS. 7A and 7B, taken along line A-A.

A set of at least two parallel, spaced-apart resonator sections of conductive material (e.g., Al or Cu) is printed as co-planar lines on a substrate between ports P1 and P2. FIGS. 7A, 7B, and 8 show, by way of example, eleven resonator sections 706 a-706k. One end of each resonator section 706a-706k (the end alternates between adjacent sections) is connected by a corresponding via 708 or 710 to both an overlaying conductive ground plane 712 and an underlying conductive ground plane 714, as shown in 7C. Dotted-line vias 708 are at a far (distal) end of the corresponding sections, and solid-line vias 710 are at a near (proximal) end of corresponding sections (not all vias are labeled to reduce clutter). Wherever the vias 708, 710 are placed, the length in Y-direction of the resonator sections 706a-706k are generally adjusted to make effective path from the ground planes 712, 714 to the free ends of the resonator sections 706a-706k equal to a quarter wavelength.

The ground planes 712, 714 are spaced from the sections 706a-706k by an insulating material (e.g., SiO₂ or PCB polymer). In some embodiments, optional busbars 716a, 716b may span the grounded end of one or more of the resonator sections 706a-706k (e.g., in FIGS. 7A and 7B, busbar 716a connecting all odd conductive sections and busbar 716b connecting all even conductive sections). Each busbar 716a, 716b with its associated resonator sections forms a “comb” like structure, with the “teeth” (resonator sections) of the two combs being interdigitated.

The lengths of the sections 706a-706k in the Y direction control the center frequency f₀ of the pseudo-HPF 700, the widths of the sections 706a-706k in the X direction control the internal impedance level of the pseudo-HPF, the spacings (which need not be uniform) between the sections 706a-706k control the bandwidth of the pseudo-HPF, and the location in the Y direction of the P1 and P2 port “tap points” control matching to an external system impedance.

An important aspect of the embodiments shown in FIGS. 7A-7C are the coupling enhancement strips 702, 704 (CES), which comprise sections of conductive material with no electrical connection (e.g., electrically floating conductive printed lines). At least one CES (702 and/or 704) is positioned spaced in the Z direction from at least the first pair (relative to port P1) of interdigitated sections (sections 706a and 706b in 7C). Optionally, at least one CES (702 and/or 704) is positioned spaced in the Z direction from at least the last pair (relative to port P1) of interdigitated sections (sections 706j and 706k in 7C). Preferably, there are at least two CES's located in the same Z-plane, with a first CES spaced in the Z direction from the first pair (relative to port P1) of interdigitated sections and a second CES spaced in the Z direction from the last pair (relative to port P1) of interdigitated sections (i.e., symmetrical placement of the CES's with respect to the first and last inter-sectional gaps). Even more preferred are two pairs of CES's, with a first pair of CES's positioned above and below the first pair (relative to port P1) of interdigitated sections and a second pair of CES's spaced above and below the last pair (relative to port P1) of interdigitated sections (i.e., symmetrical over-and-under placement of the pairs of CES's with respect to the first and last inter-sectional gaps). Each CES 702, 704 is aligned longitudinally with the associated pair of interdigitated sections and overlaps both sections of the associated pair of interdigitated sections (i.e., across the inter-sectional gap). The amount of overlap may be varied in some designs.

In some embodiments, additional CES's may be added. For example, FIG. 8 is a cross-sectional view of an improved printed interdigitated-line eleventh-order pseudo-HPF 800 that includes added CES's 702′, 704′. The added CES's 702′, 704′ overlap the second pair and second-to-last pair (relative to port P1) of interdigitated sections (in FIG. 8, sections 706b & 706c and sections 706i & 706j). Shown in dotted outline are additional locations T (for top) and B (for bottom) at which one or more CES's may be placed.

If the couplings between all adjacent resonator sections 706a-706k are increased, the bandwidth of the filter will also increase and IL will decrease. The couplings may be increased by means of closer spacing between the resonator sections 706a-706k and/or the addition of more CES's. Since manufacturing close spacing (small gaps) between the resonator sections 706a-706k becomes increasingly difficult as gap size decreases, an easier way to increase coupling is by adding CES's, as in FIG. 8.

Note that the CES's need not all be in same plane as suggested by FIGS. 7C and 8; that is, some of the CES's may be spaced in the Z dimension farther or closer to their associated pair of interdigitated resonator sections relative to other CES's. Further, added CES's need not be placed spaced from adjacent inter-sectional gaps, as suggested by FIG. 8; that is, CES's may be positioned with respect to non-adjacent inter-sectional gaps (i.e., skipping some gaps), such as (as one example only) the gaps between sections 706a/706b, 706e/706f, and 706j/706k. In some embodiments, it may be useful for a CES to span two or more adjacent inter-sectional gaps, such as one CES section spanning the gap between sections 706a/706b and the gap between sections 706b/706c. The CES's may be “tuned” to meet the needs of particular applications by adjustments to their length, width, offset with respect to an associated inter-sectional gap, and spacing in the Z dimension from an associated pair of interdigitated resonator sections.

The order of formation of the elements illustrated in FIGS. 7C and 8 on a substrate (e.g., an Si wafer) may be, as one example: depositing the underlying conductive ground plane 714, depositing an insulating material (e.g., SiO₂), depositing (e.g., printing) the lower CES elements 702, depositing an insulating material, depositing the interdigitated resonator sections 706a-706k, depositing an insulating material, depositing the upper CES elements 704, depositing an insulating material, and depositing the overlying conductive ground plane 712, with vias 708, 710 (or portions of those vias) being formed as needed during the process. Alternatively, the layered structures shown in FIGS. 7C and 8 may be fabricated in a manner similar to multi-layer ceramic capacitors, in which multiple printed ceramic-based green sheets are stacked together and pressed (laminated) into a final structure. Through-vias may be formed and then filled with a suitable conductor (e.g., Al or Cu). Through-vias may be formed using a number of techniques, including laser drilling through the laminated stack. In alternative processes, through-vias may be formed before capacitor plate printing and stacking by punching holes through the ceramic green sheet and filling the holes with a conductor.

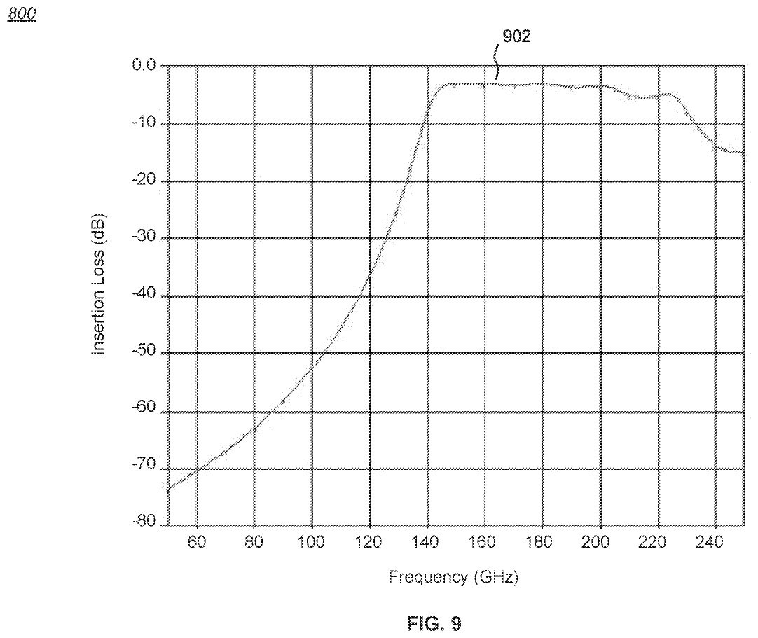

FIG. 9 is a graph 900 of RF signal insertion loss as a function of frequency for a model of the pseudo-HPF 700 of 7C (i.e., an 11^{th} order interdigitated pseudo-HPF having CES's both above and below the first and last inter-sectional gaps). Graph line 902 exhibits a wide passband from about 140 GHz to about 200 GHz, and excellent low-side attenuation at and below about 120 GHZ.

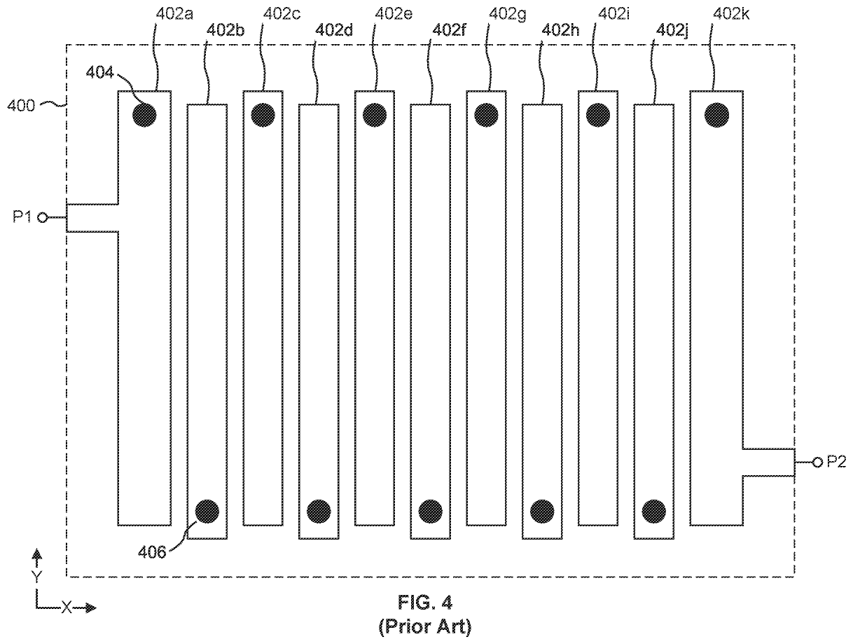

Note that in conventional printed interdigitated-line BPFs, the inter-sectional gaps between the first pair (relative to port P1) of interdigitated resonator sections (sections 402a and 402b in FIG. 4) and the last pair (relative to port P1) of interdigitated resonator sections (sections 402j and 402k in FIG. 4) are narrower than the other inter-sectional gaps to achieve a required degree of coupling. These narrow gaps are the most difficult to manufacture. However, because of the presence of CES's in a pseudo-HPF, the first pair and last pair inter-sectional gaps do not have to be as narrow, thus easing manufacturing constraints.

In summary, CES's in combination with a printed interdigitated-line BPF topology creates a pseudo-HPF that lower IL and widen bandwidth to emulate HPF functionality.

Improved BPF Architecture Use of CES's in conjunction with a printed interdigitated-line BPF topology creates a wide-bandwidth pseudo-HPF that provides deeper low-side stopband attenuation and offers flexibility for independent high/low-frequency selectivity (in contrast to a single bandpass filter. Combining a pseudo-HPF with a printed-line LPF results in an improved wide-band, low-IL BPF.

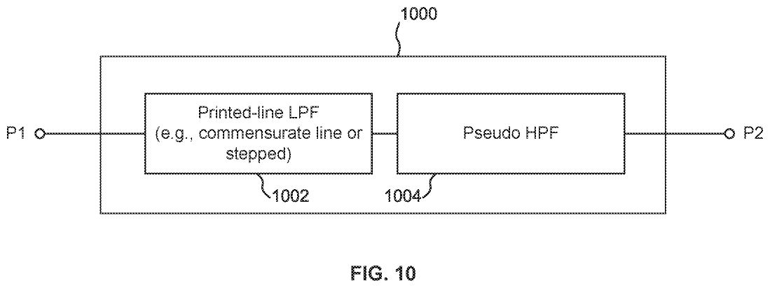

FIG. 10 is a block diagram of an improved cascaded BPF 1000 comprising a printed-line LPF 1002 and a pseudo-HPF 1004. The printed-line LPF 1002 is preferably a commensurate-line LPF (see, e.g., FIG. 5C), but a stepped LPF (see, e.g., FIG. 5B) or other type of LPF design may be suitable in some applications. The pseudo-HPF 1004 is an instance or variant of the pseudo-HPF designs shown in FIGS. 7A-7C and 8.

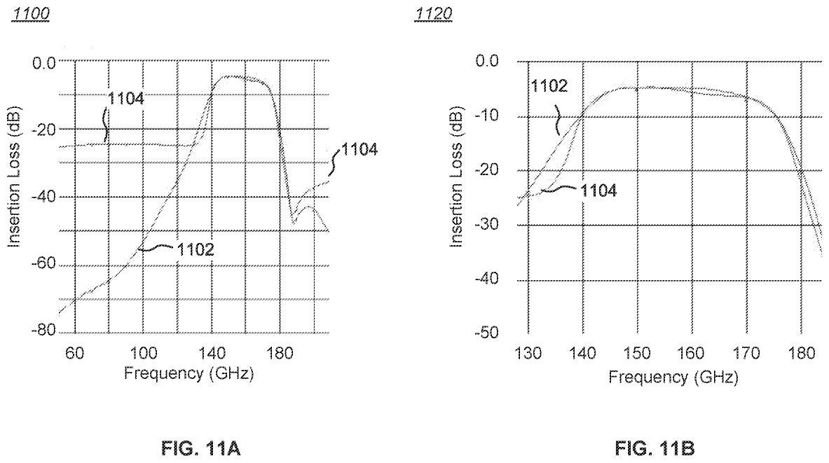

FIG. 11A is a graph 1100 of RF signal insertion loss as a function of frequency for two different modeled BPF designs, one being a single BPF and one being a cascaded BPF. FIG. 11B is an enlarged portion 1120 of the graph 1100 of FIG. 11A. The model for each BPF design was of a Chebyshev BPF having a 0.5 dB ripple band shape, with f₀≈160 GHz, f_{EL}≈145 GHz, f_{EH}≈175 GHz, f_{AL}≈115 GHZ, f_{AH}≈185 GHz, and L_{MAX_L}=L_{MAX_H}=40 dB.

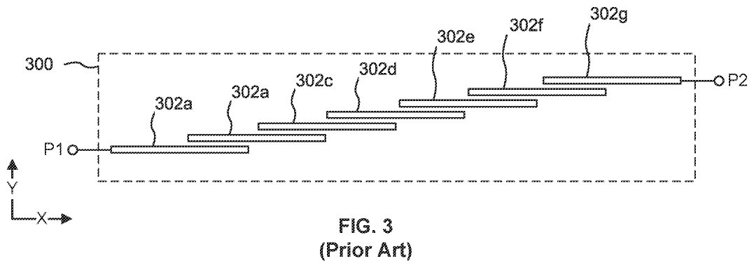

Graph line 1102 shows the response of one embodiment of the improved cascaded BPF 1000 of FIG. 10 with equivalent single-filter order N=5, and is essentially graph line 606 from FIG. 6 (N=9) multiplied by (or summed with, when in decibels) graph line 802 from FIG. 9 (N=11). Graph line 1104 shows the response of one embodiment of the conventional single fifth-order parallel-coupled printed-line BPF 300 of FIG. 3. Both modeled filters have the same substrate configuration (same printed line materials and total thickness), dielectric tan(8) (1.6e-3), and DC bulk resistivity (1.7e-8 ohm*m).

Concatenating the preferred LPF with the novel pseudo-HPF results in a cascaded BPF having a wide passband (about 30 GHz at −10 dB, and almost 50 GHz at −25dB), narrow transition bands, and wide low-side and high-side stopbands with attenuation of at least about −36 dB for all required stopband frequencies below about 230 GHz.

As the graphs indicate, the IL down to about −25 dB is almost exactly the same for the improved cascaded BPF 1000 and the “equivalent-selectivity” single BPF. However, the graph line 1102 for the improved cascaded BPF 1000 shows better low-side and high-side attenuation (up to about 230 GHz). Of note, the selectivity of the cascaded BPF 1000 is equivalent to a single BPF of order N=5, even though the example LPF 1002 and pseudo-HPF 1004 have orders 9 and 11, respectively.

### Variant Coupling Enhancement Strip Designs

The existence and placement of a low-side zero can increase the selectivity of a pseudo-HPF, and hence of the selectivity of a cascaded BPF. Destructive interference at certain low-side frequencies between directly coupled and cross-coupled signals that are of opposite phase and approximately equal amplitude create zero notches. In essence, near a zero point, cross-coupled frequencies that are of opposite phase and approximately equal amplitude substantially cancel out frequencies directly coupled between resonator sections.

A low-side zero may be created or improved from a cross-coupling between specially designed CES's near interdigitated resonator sections adjacent to port P1 and port P2. An input signal applied to port P1 is directly coupled (by capacitive and inductive coupling) from resonator section to resonator section to port P2. A portion of the input signal is also capacitively and inductively coupled to the CES's nearest port P1, then capacitively and/or inductively cross-coupled to the CES's nearest port P2 and then coupled back into port P2, skipping over underlying or overlying resonator sections. Simulations have shown that the placement of a low-side zero created in such a manner may be controlled by enhancing aspects of the cross-coupled signal passing between CES's.

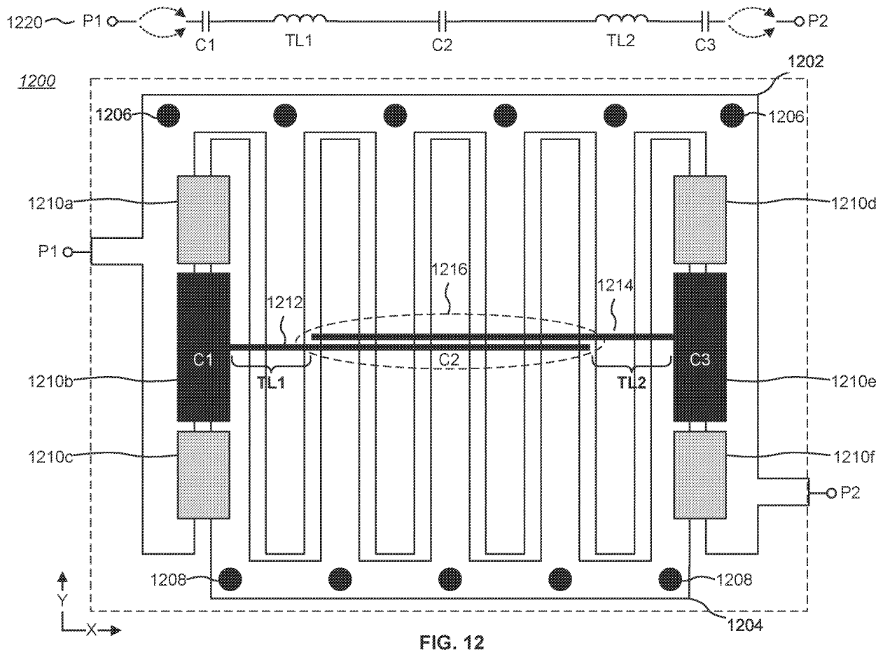

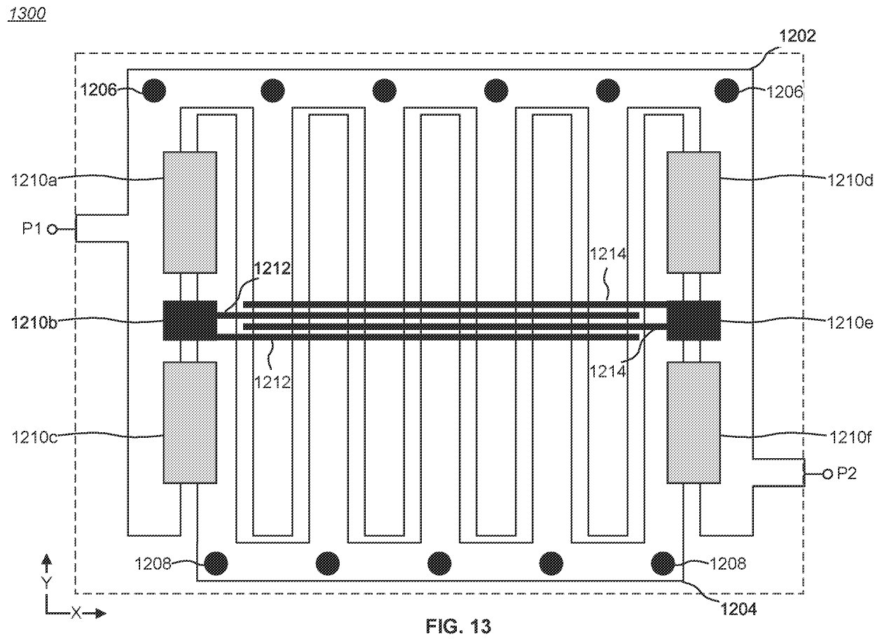

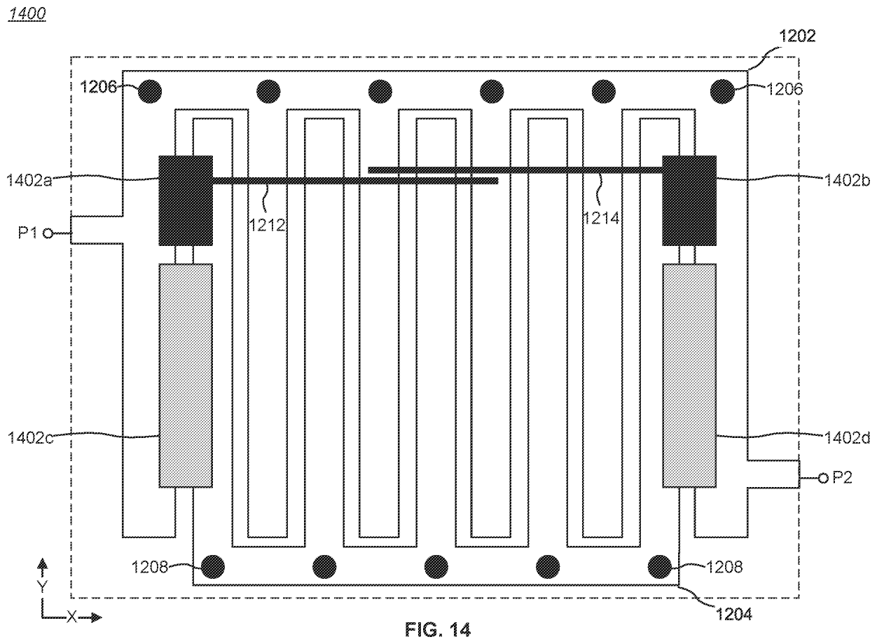

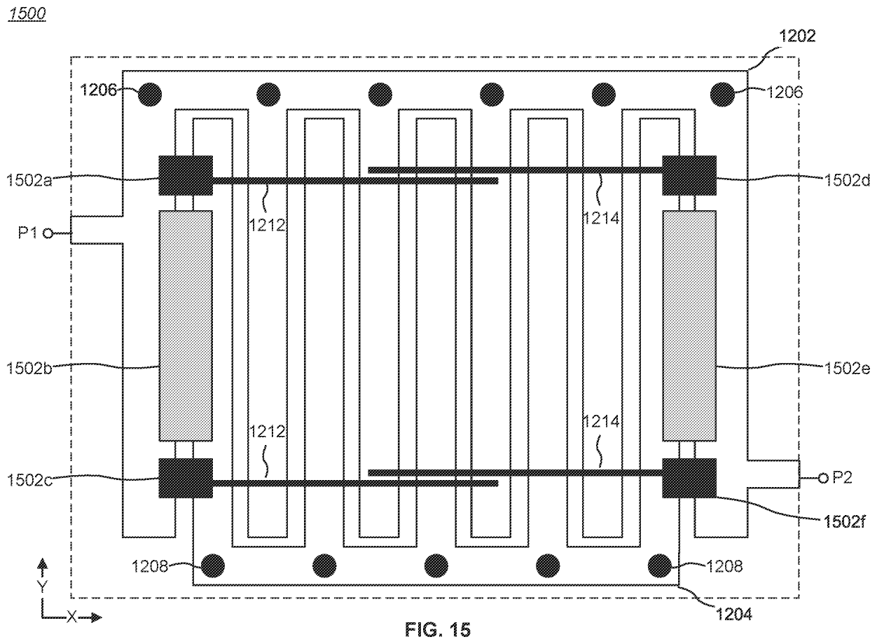

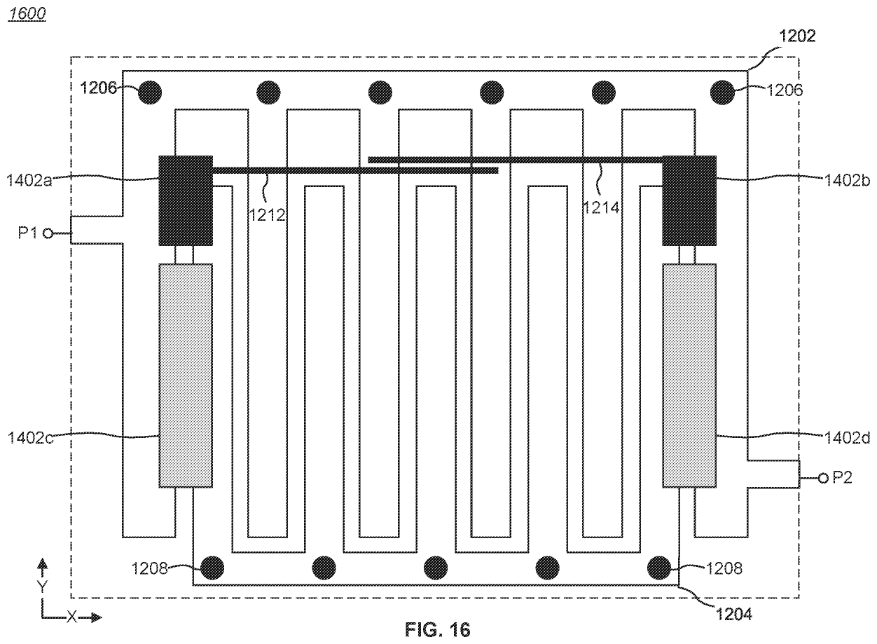

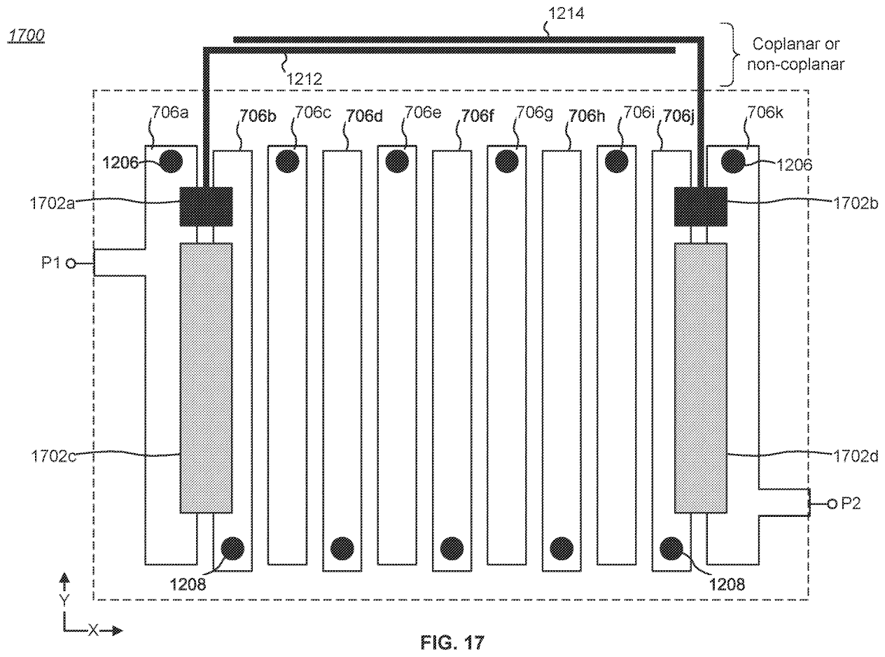

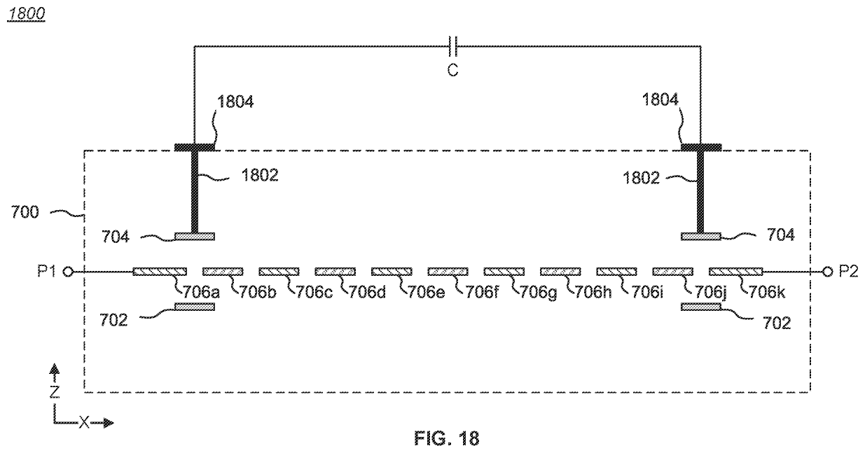

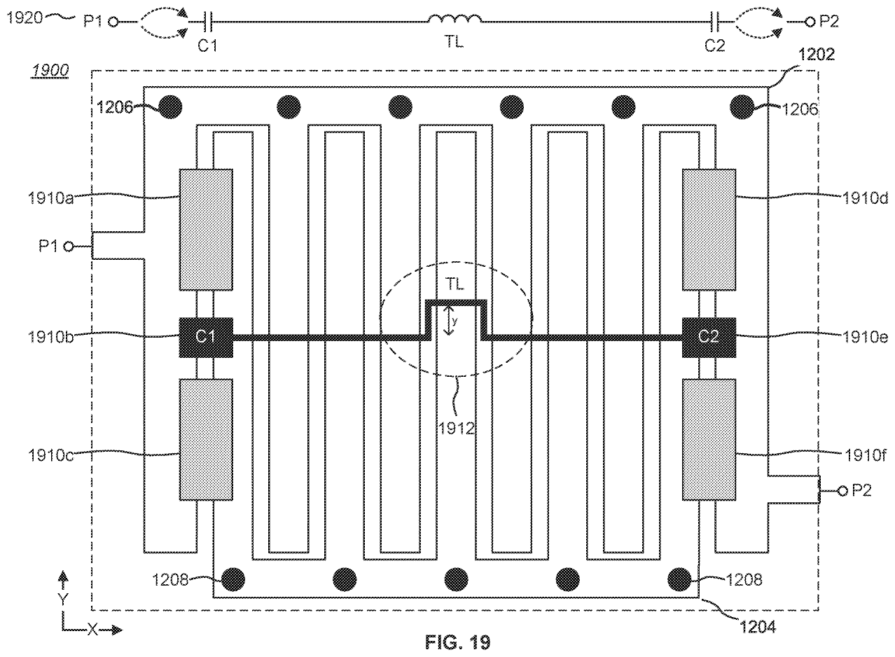

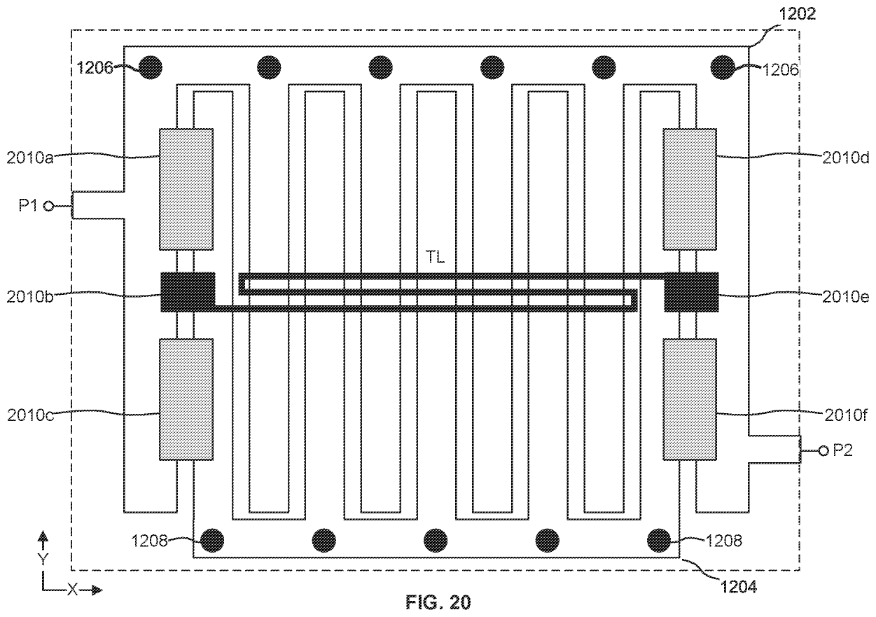

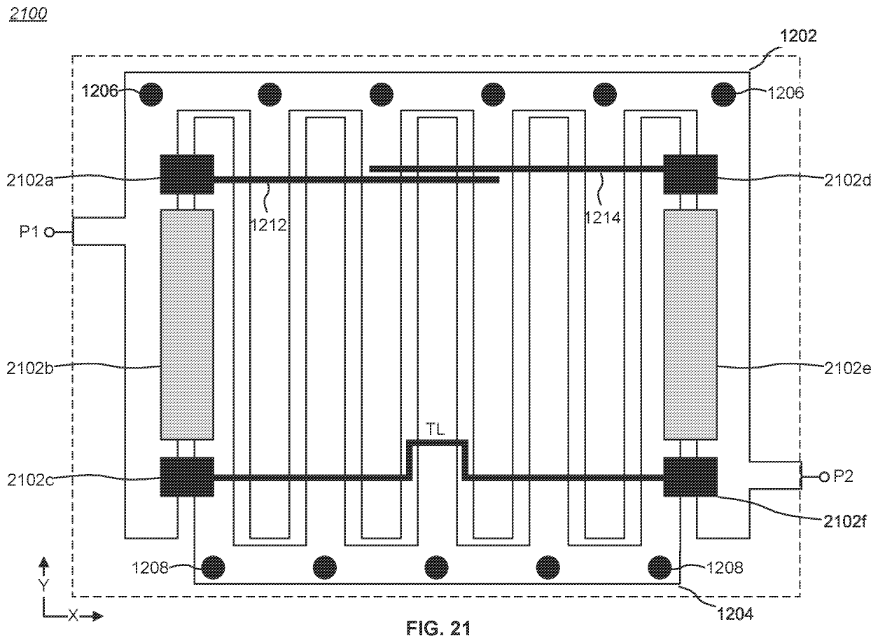

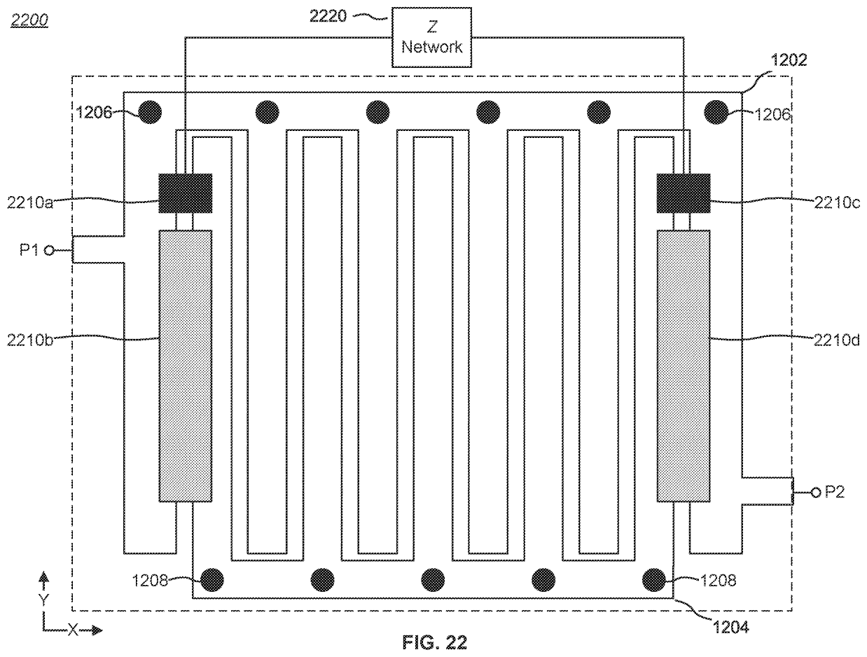

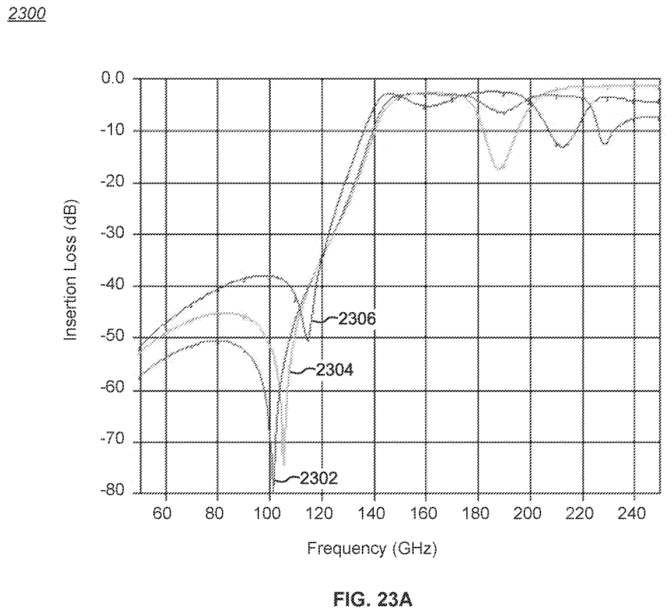

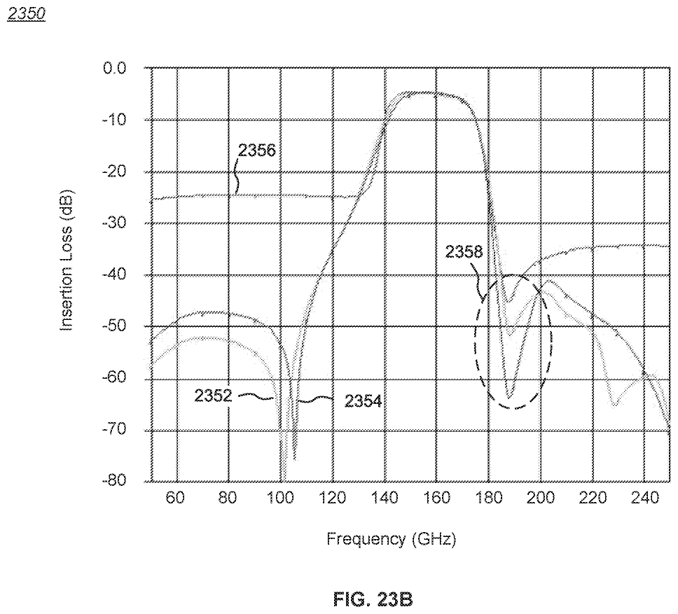

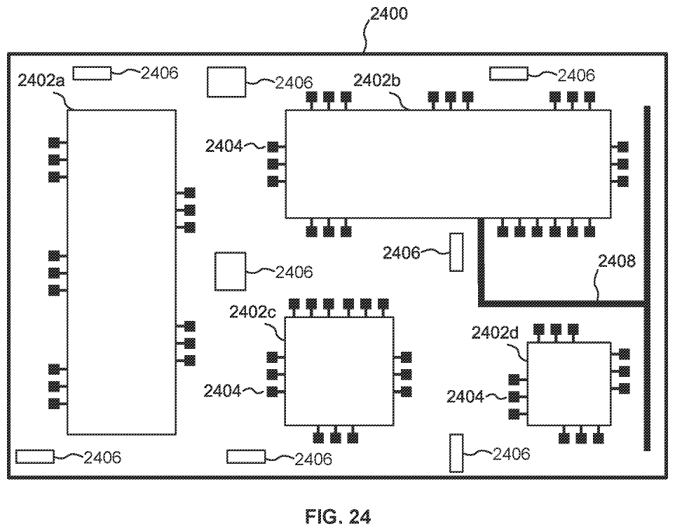

For example, FIG. 12 is a plan view of the layout of a first variant pseudo-HPF 1200. A first resonator comb 1202 of resonator sections is interdigitated with a second resonator comb 1204 of resonator sections, similar to the embodiment shown in FIG. 7B. One end of each resonator section is connected by a corresponding via 1206 or 1208 to both an overlaying conductive ground plane and an underlying conductive ground plane, as shown in FIG. 7C (not all vias are labeled to reduce clutter).

The embodiment shown in FIG. 7B has a unitary CES overlying the first pair (nearest port P1) and the last pair (nearest port P2) of resonator sections. In the example embodiment illustrated in FIG. 12, adjacent to port P1 is a discontinuous CES comprising three CES subsections 1210a-1210c. Similarly, adjacent to port P2 is a discontinuous CES comprising three subsections 1210d-1210f. Underlying the first and second resonator combs 1202, 1204 may be unitary or discontinuous CES's (not shown).

The central CES subsections 1210b, 1210e include corresponding conductive printed line extensions 1212, 1214 that overlap within dashed oval 1216. Electrically, the main bodies of the CES subsections 1210b, 1210e each still perform the function of a coupling enhancement strip (as do the remaining CES subsections), comprising respective coupled capacitors C1, C3 (to a first order approximation-the main bodies would generally include resistance and inductance characteristics as well). The non-overlapping portion of the extensions 1212, 1214 have the characteristics of transmission lines TL1, TL2 that have the characteristics of inductors (to a first order approximation-the transmission lines TL1, TL2 would generally include resistance and capacitance characteristics as well, keeping in mind that a transmission line can simply be a conductive printed line of a properly controlled width). The overlapping portion of the extensions 1212, 1214 form a capacitor C2 (again, to a first order approximation-the overlapping lines would generally include resistance and inductance characteristics as well). The illustrated central CES subsections 1210b, 1210e may thus be modeled, to a first order approximation, by the equivalent C-L-C-L-C circuit 1220 shown next to the layout of the pseudo-HPF 1200. In the equivalent C-L-C circuit 1220, the dotted-line arrows represent electromagnetic coupling of the central CES subsections 1210b, 1210e to corresponding end resonator strips within the resonator combs 1202, 1204, which are in turn coupled to respective ports P1 and P2.

Thus, rather than rely upon fringes of electromagnetic fields emanating from the main body of subsection 1210b cross-coupling to the main body of subsection 1210e, the extensions 1212, 1214 provide for a more direct form of cross-coupling which strengthens the amount of cross-coupled signal that can interact with the directly coupled signal propagated through the interdigitated resonator sections of the first and second resonator combs 1202, 1204. The resulting simulations show the creation of a low-side zero (see discussion below regarding FIG. 23A).

The electrical characteristics of the capacitively-coupled CES subsections 1210b, 1210e may be adjusted by varying one or more of the width (in the Y dimension) of the main bodies of those subsections (thus changing the capacitance of the main body), the amount of overlap of the extensions 1212, 1214 forming capacitor C2, the spacing between the extensions 1212, 1214 (narrower spacing results in greater capacitive coupling), and/or the width (in the Y dimension) of the extensions 1212, 1214. In an example embodiment designed for an f0 of about 150 GHz, the X-dimension of the entire pseudo-HPF 1200 may be less than about 1 mm, and the width (in the Y dimension) of the printed line extensions 1212, 1214 may be about 1-2 microns.

Capacitively-coupled CES subsections 1210b, 1210e may be placed over, or under, or both over and under the first and second resonator combs 1202, 1204 as another design option for controlling the amount of cross-coupling through the CES's and thus control of the characteristics of the low-side zero. Since the extensions 1212, 1214 span across two or more resonator sections, the extensions 1212, 1214 provide some additional coupling enhancement of the type described with respect to FIGS. 7A-7C and 8, which may not be desirable for some applications, but which can be reduced if needed by making the extensions 1212, 1214 narrow.

Another design option for controlling the amount of cross-coupling through the CES's is to control the amount of capacitance exhibited by the overlapping extensions 1212, 1214—more capacitance generally translates to moving the low-side zero closer to the bandpass of a pseudo-HPF. For example, FIG. 13 is a plan view of the layout of a second variant pseudo-HPF 2500. In the illustrated example, the CES subsections 1210b, 1210e each have two respective extensions 1212, 1214. For extensions 1212, 1214 of the same overlap length (in the X dimension) as the embodiment shown in FIG. 12, the 4-extension embodiment shown in FIG. 13 will have three times more capacitance than the 2-extension embodiment shown in FIG. 12. In addition, the multiple extensions 1212, 1214 spanning across two or more resonator sections provide additional coupling enhancement of the type described with respect to FIGS. 7A-7C and 8.

It should be noted that adding capacitively-coupled CES subsections to a pseudo-HPF will in general not provide the proper phase for the cross-coupled signal, particularly if the capacitance is provided by an external capacitor. However, the cross-coupled signal phase may be altered by adjusting the lengths of the transmission lines TL1, TL2, including by adding meandering printed line paths (see FIGS. 19 and 20 for examples), or by adding phase-shifting elements (e.g., inductors) in the signal path through the capacitor.

Other placements of the capacitively-coupled CES subsections having extensions 1212, 1214 may be used. For example, FIG. 14 is a plan view of the layout of a third variant pseudo-HPF 1400. In the illustrated example, capacitively-coupled CES subsections 1402a, 1402b each have a respective extension 1212, 1214, but multiple extensions may be used, as in the embodiment of FIG. 13. The main bodies of both capacitively-coupled CES subsections 1402a, 1402b are in an end position with respect to an associated single adjacent CES subsection 1402c, 1402d, rather than in the middle position shown in FIGS. 12 and 25. Placing the capacitively-coupled CES subsections 1402a, 1402b closer to the ground plane vias 1206 and the busbar portion of the first resonator comb 1202 may cause less disturbance to the bandpass characteristics of the pseudo-HPF 1400 due to the influence of the conductive printed-line extensions 1212, 1214 overlaying the resonator sections.

As another example, FIG. 15 is a plan view of the layout of a fourth variant pseudo-HPF 1500. In the illustrated example, two pairs of capacitively-coupled CES subsections 1502a, 1502d and 1502c, 1502f each have a respective extension 1212, 1214, but multiple extensions may be used, as in the embodiment of FIG. 13. The main bodies of both pairs of CES subsections 1502a, 1502d and 1502c, 1502f are in an end position with respect to an associated adjacent CES subsection 1502b, 1502e. Placing the capacitively-coupled CES subsections 1502a, 1502d and 1502c, 1502f closer to respective ground plane vias 1506, 1506 and the busbar portions of the first and second resonator combs 1202, 1204 may cause less disturbance to the bandpass characteristics of the pseudo-HPF 1500.

FIG. 16 is a plan view of the layout of a fifth variant pseudo-HPF 1600. The illustrated embodiment is similar in most aspects to the embodiment shown in FIG. 14. In particular, capacitively-coupled CES subsections 1602a, 1602b each have a respective extension 1212, 1214, but multiple extensions may be used, as in the embodiment of FIG. 13. However, the first and second resonator combs 1202, 1204 are dimensioned so that a space is available to allow the extensions 1212, 1214 to cross only the resonator sections of the first resonator comb 1202, thereby reducing the influence of the conductive printed-line extensions 1212, 1214 on the resonator sections. The embodiment of FIG. 15, with two pairs of capacitively-coupled CES subsections 1502a, 1502d and 1502c, 1502f, may be similarly adapted so that each pair of extensions 1212, 1214 only crosses the resonator sections of one of the first resonator comb 1202 or the second resonator comb 1204.

FIG. 17 is a plan view of the layout of a sixth variant pseudo-HPF 1700. The illustrated embodiment lacks busbars 716a, 716b connecting related resonator sections, as in FIG. 7B, but such busbars may be used. In the illustrated example, capacitively-coupled CES subsections 1702a, 1702b each have a respective extension 1212, 1214, but multiple extensions may be used, as in the embodiment of FIG. 13. The main bodies of both capacitively-coupled CES subsections 1702a, 1702b are in an end position with respect to an associated single adjacent CES subsection 1702c, 1702d. In the illustrated embodiment, the extensions 1212, 1214 are routed to an offset position with respect to the pseudo-HPF 1700 so as to avoid crossing any of the resonator sections 706a-706k of the pseudo-HPF 1700, thus reducing the influence of the conductive printed-line extensions 1212, 1214 on the resonator sections 706a-706k.

It should be understood that the overlapping extensions 1212, 1214 of the capacitively-coupled CES subsections 1702a, 1702b need not be in the same plane as the main bodies of the capacitively-coupled CES subsections 1702a, 1702b. For example, in an IC or PCB implementation of the pseudo-HPF 1700, vias may be formed from the main bodies of the capacitively-coupled CES subsections 1702a, 1702b to overlapping extensions 1212, 1214 formed or printed in a different Z-layer of metallization. Moving the overlapping extensions 1212, 1214 further away from the resonator sections 706a-706k should reduce the influence of the extensions 1212, 1214 on the resonator sections 706a-706k. A non-coplanar Z-layer positioning of the extensions 1212, 1214 would allow busbars 716a, 716b to be used while avoiding having the extensions 1212, 1214 routed over (or under) any part of the busbars 716a, 716b or resonator sections 706a-706k.

In some embodiments, the extensions 1212, 1214 may be routed to a different Z-layer of metallization and positioned such that one of the conductive ground planes 712, 714 is positioned between the overlapping portions of the extensions 1212, 1214 and the resonator sections 706a-706k. Such a configuration may further shield the resonator sections 706a-706k from being influenced by the extensions 1212, 1214. Note that in practice, the extensions 1212,1214 generally will also exhibit unwanted parasitic capacitance to the nearest ground plane. It may be desirable, or even necessary, to account for this phenomenon in the design, such as by maintaining a relatively large separation in the Z dimension between the ground planes 712, 714 and the extensions 1212,1214 to minimize the unwanted parasitic capacitance to ground.

A version of the embodiment shown in FIG. 17 having non-coplanar Z-layer positioning of the extensions 1212, 1214 may be further generalized. As noted previously, more capacitance between capacitively-coupled CES subsections generally translates to moving the low-side zero closer to the bandpass of a pseudo-HPF. Accordingly, it may be useful in some embodiments to utilize an external fixed capacitor or a digitally-tunable capacitor (DTC) to provide greater (and possibly tunable) capacitance between capacitively-coupled CES subsections. For example, FIG. 18 is a cross-sectional view of a variant pseudo-HPF 1800 based on the pseudo-HPF 700 of FIG. 7C (the ground planes 712, 714 and connecting vias 708, 710 are omitted to avoid clutter). In the illustrated example, conductive vias 1802 are formed from two CES's 704 to, for example, respective contact pads 1804. A capacitor C (which may be a DTC) is shown connected between the contact pads 1804. As noted above, the connecting conductors (e.g., printed line traces or vias) to the capacitor C generally should be adjusted to get the proper cross-coupled phase to accompany the magnitude that is set by the value of C. Such a configuration thus allows an additional degree of design freedom in optimizing the pseudo-HPF 1800 for particular applications (e.g., different frequency ranges and f0 values).

At an f0 around 150 GHz, the capacitance of capacitor C may only be in 10′s of femtofarads. At lower center frequencies, the capacitance of capacitor C would generally increase. The capacitor C may be located in a different part of the structure (e.g., IC or PCB) that includes the pseudo-HPF, or may be located in a different structure, such as another IC. The capacitor C may be, for example, a discrete multi-layer ceramic capacitor (MLCC) or an integrated MIM (metal-insulator-metal), MOM (metal-oxide-metal), or MOS (metal-oxide-semiconductor) capacitor. A DTC may be of the type described in U.S. Pat. No. 9,024,700, issued on May 5, 2015, entitled “Method and Apparatus for use in Digitally Tuning a Capacitor in an Integrated Circuit Device”, or in U.S. Pat. No. 9,197,194, issued on Nov. 24, 2015, entitled “Method and Apparatus for Use in Tuning Reactance in a Circuit Device”, the contents of both of which are hereby incorporated by reference.

The embodiments shown in FIGS. 12-18 have focused on capacitively-coupled CES subsections. However, in some embodiments, a similar benefit regarding generation and placement of low-side zeros may be achieved by the use of inductively-coupled CES subsections.

For example, FIG. 19 is a plan view of the layout of a seventh variant pseudo-HPF 1900. A first resonator comb 1202 of resonator sections is interdigitated with a second resonator comb 1204 of resonator sections, similar to the embodiment shown in FIG. 7B. One end of each resonator section is connected by a corresponding via 1206 or 1208 to both an overlaying conductive ground plane and an underlying conductive ground plane, as shown in FIG. 7C (not all vias are labeled to reduce clutter).

In the example embodiment illustrated in FIG. 19, adjacent to port P1 is a discontinuous CES comprising three CES subsections 1910a-1910c. Similarly, adjacent to port P2 is a discontinuous CES comprising three subsections 1910d-1910f. Underlying the first and second resonator combs 1202, 1204 may be unitary or discontinuous CES's (not shown).

The central CES subsections 1910b, 1910e include main bodies that each still perform the function of a coupling enhancement strip (as do the remaining CES subsections) and comprise respective coupled capacitors C1, C2 (to a first order approximation). A transmission line coupling strip TL, which performs more nearly like an inductor the narrower the printed strip, connects the main bodies of the CES subsections 1910b, 1910e. The length of the coupling strip TL may be adjusted by including one or more vertical (with respect to the page) meandering sections (with dashed oval 1912) and adjusting the “y” dimension of one or more of those sections. The illustrated central CES subsections 1910b, 1910e may thus be modeled, to a first order approximation, by the equivalent C-L-C circuit 1920 shown next to the layout of the pseudo-HPF 1900. In the equivalent C-L-C circuit 1920, the dotted-line arrows represent electromagnetic coupling of the central CES subsections 1910b, 1910e to corresponding end resonator strips within the resonator combs 1202, 1204, which are in turn coupled to respective ports P1 and P2.

The inductor-like characteristics of the coupling strip TL are enhanced by making the width (in the Y dimension) of the coupling strip TL narrower. As should be appreciated, the positioning of the CES subsections 1910b, 1910e may be altered to be on an end of (rather than between) the other CES's, and there may be more than one set of inductively-coupled CES subsections 1910b, 1910e (i.e., parallel inductive coupling strips TL). There are other ways of meandering the coupling strip TL as well. For example, FIG. 20 is a variant of the embodiment pseudo-HPF 1900 shown in FIG. 19 in which the coupling strip TL has horizontal (with respect to the page) meandering sections. A coupling strip TL may also include a combination of vertical meandering sections and horizontal meandering sections. Further, the capacitance-based non-coplanar structures shown in FIGS. 17 and 18 may be adapted to be inductance-based structures by replacing the overlapping extensions 1212, 1214 of FIG. 17 and the external capacitor C of FIG. 18 with integrated or external inductors. Thus, for example, vias may be used to connect the coplanar main bodies of CES subsections 1910b, 1910e to non-coplanar inductors, such as an integrated coil inductor formed in a different metallization layer of an IC embodiment of the pseudo-HPF 1900. Such a non-coplanar inductor may be vertically aligned (in the Z dimension) over the pseudo-HPF 1900 or offset (in the X and/or Y dimensions) from the pseudo-HPF 1900.

It may be useful in some applications to include both capacitively-coupled CES subsections and inductively-coupled CES subsections. For example, FIG. 21 is a plan view of the layout of an eighth variant pseudo-HPF 1900. Adjacent to port P1 is a discontinuous CES comprising three CES subsections 2102a-2102c. Similarly, adjacent to port P2 is a discontinuous CES comprising three subsections 2102d-2102f. Underlying the first and second resonator combs 1202, 1204 may be unitary or discontinuous CES's (not shown). The CES subsections 2102a, 2102d on a first end of the discontinuous CES's comprise capacitively-coupled CES subsections, while the CES subsections 2102c, 2102f on a second end of the discontinuous CES's comprise inductively-coupled CES subsections. The coupling strip TL of the inductively-coupled CES subsections 2102c, 2102f is shown with a vertical meander, but a horizontal meander or combination of vertical and horizontal meanders may be used. The overlapping extensions 1212, 1214 of the capacitively-coupled CES subsections 2102a, 2102d may be coplanar or non-coplanar, or replaced by an external capacitor.

The concept of capacitively-coupled CES subsections and/or inductively-coupled CES subsections can be more generally stated to include CES subsections having main bodies coupled by a complex impedance network. For example, FIG. 22 is a plan view of the layout of a ninth variant pseudo-HPF 2200. Adjacent to port P1 is a discontinuous CES comprising two CES subsections 2202a-2202b. Similarly, adjacent to port P2 is a discontinuous CES comprising two subsections 2202c-2202d. Underlying the first and second resonator combs 1202, 1204 may be unitary or discontinuous CES's (not shown).

In the illustrated example, CES subsections 2202a, 2202c are coupled to a complex impedance (Z) network 2220. For the exemplary case of a series RLC circuit, Z=R+jωL−j/ωC and ω=2πf. Accordingly, those subsections 2202a, 2202c may be regarded as “Z-coupled” CES subsections. For a series RLC circuit, the magnitude of Z may also be computed as Z=\sqrt{R²+(X_{L}−X_{C})²} where R=resistance, X_{L}=inductive reactance, and X_{C}=capacitive reactance. Other formulas for the magnitude of Z for other types of impedance networks (e.g., series RL, series RC, series LC, parallel RL, parallel RC, parallel LC, and parallel RLC) are known in the art.

The Z network 2220 may include components that are printed line capacitors (e.g., extensions 1212, 1214 in FIG. 12) or printed line inductive transmission lines (e.g., transmission line coupling strip TL in FIG. 19), and may include discrete and/or integrated circuit elements, including capacitors, inductors, and/or resistors. The Z network 2220 may be coplanar with the main bodies of the CES subsections 2202a, 2202c, or situated in a different metallization layer or layers, or may be external to the structure (e.g., IC or PCB) embodying the pseudo-HPF 2200.

Z-coupled CES subsections of any of the configurations shown in FIGS. 12-22 may be placed over, or under, or both over and under the first and second resonator combs 1202, 1204 or resonator sections 706a-706k as another design option for controlling the amount of cross-coupling through the CES's and thus for controlling the characteristics of the low-side zero of a pseudo-HPF. For example, referring to FIG. 21, the capacitively-coupled CES subsections 2102a, 2102d may overlay the first and second resonator combs 1202, 1204, while the inductively-coupled CES subsections 2102c, 2102f may underlie the first and second resonator combs 1202, 1204. In some embodiments, a pseudo-HPF may include only a pair of Z-coupled CES subsections, each located near the P1 and P2 ports respectively; that is, the set of CES subsections near each port comprises only one member. As should be clear, any of the Z-coupled CES subsections may be included in a pseudo-HPF 1004 that is combined with a printed-line LPF 1002 to form an improved cascaded BPF 1000.

FIG. 23A is a graph 2300 of RF signal insertion loss as a function of frequency for a model of the pseudo-HPF 2200 of FIG. 22 coupled to various values of capacitance within the impedance network 2220. Graph line 2302 exhibits a wide passband from about 140 GHz to about 200 GHz, and excellent low-side attenuation at and below about 120 GHz. Graph line 2304 exhibits a wide passband from about 140 GHz to about 180 GHz, and excellent low-side attenuation at and below about 120 GHz, but with a zero having less insertion loss but closer to the passband than graph line 2302. Graph line 2306 exhibits a wide passband from about 140 GHz to about 200 GHz, and excellent low-side attenuation at and below about 120 GHz. While graph line 2306 exhibits a zero having less insertion loss than graph lines 2302 and 2304, the zero is located closer to the passband, increasing selectivity. Thus, a designer has excellent flexibility in choosing the location and loss value for a zero versus selectivity.

FIG. 23B is a graph 2350 of RF signal insertion loss as a function of frequency for two modeled cascaded BPFs utilizing the pseudo-HPF 2200 of FIG. 22. More specifically, graph line 2352 shows the response expected from one embodiment of the improved cascaded BPF 1000 of FIG. 10 with equivalent single-filter order N=5, and is essentially graph line 606 from FIG. 6 (N=9) multiplied by (or summed with, when in decibels) graph line 2302 from FIG. 23A (N=11). Graph line 2354 shows a variant configuration that is essentially graph line 606 from FIG. 6 multiplied by (or summed with, when in decibels) graph line 2304 from FIG. 23A. For reference, graph line 2356 shows the response of one embodiment of the conventional single fifth-order parallel-coupled printed-line BPF 300 of FIG. 3.

Concatenating the preferred LPF with the novel pseudo-HPF results in a cascaded BPF having a wide passband (about 35 GHz at −10 dB, and almost 50 GHz at −25 dB), narrow transition bands, and wide low-side and high-side stopbands with attenuation of at least about −36 dB for all required stopband frequencies below about 230 GHz. A comparison of graph line 2356 to graph lines 2352 and 2354 shows that the passband characteristics are nearly identical, while the cascaded BPF utilizing the pseudo-HPF 2200 provides dramatically better low-side IL performance and better high-side IL performance.

Graph line 2352 has a sharp zero at just over about 100 GHz, while graph line 2354 has a sharp zero at about 105 GHz. The presence of the zeroes increases the selectivity of the cascaded BPF. Further, the ability to adjust the location of the zeroes relative to the passband by changing the characteristics of the Z network 2220 in FIG. 22 provides flexibility to independently design for different selectivity requirements on the low-side and high-side of the passband.

Note also that FIG. 23B shows deepened zeroes on the high-side of the passband around 187 GHz (see graph line portions in ovel 2358), the presence of which improves high-side selectivity. This characteristic is an unexpected bonus for some combinations of design element values, as it is mainly the LPF portion of a cascaded BPF that is responsible for the high-frequency-side transition band. However, a single cross-coupled signal can sometimes create more than one zero if it happens to have equal amplitude and opposite phase as the main signal at more than one frequency.

In some other embodiments, cross couplings like those shown in FIGS. 12-22 may be used that result in ports P1 and P2 being brought closer to each other. For example, such cross couplings may interconnect internal resonators. In other examples, folding may be used to bring ports P1 and P2 together, e.g., a “folded” interdigitated layout. An example of “folding” may be to have three ground planes, with interdigitated resonators on two different layers (e.g., an upper resonator layer between an upper ground plane and a middle ground plane, and a lower resonator layer between the middle ground plane and a lower ground plane). A signal is coupled from port P1 to a first internal midpoint resonator in the upper resonator layer, then vias are used to transfer the signal down to a second internal midpoint resonator in the lower resonator layer, and the signal is coupled back in the X-direction to port P2. Thus, the last resonator with port P2 can be positioned physically directly below the first resonator with port P2; port P2 may even be positioned directly below port P1. As a result, the distance between the first CES on the upper resonator plane and the last CES on the lower resonator plane may be quite short. As a consequence, cross couplings like those shown in FIGS. 12-22 can be made with very small structures, thereby approaching ideal capacitors and/or inductors. The middle ground plane blocks most direct coupling between the upper-layer resonators and the lower-layer resonators (noting that small openings in the middle ground plane may facilitate various types of cross-couplings between various combinations of resonators).

In summary, Z-coupled CES's in combination with a printed interdigitated-line BPF topology creates a pseudo-HPF that provide two advantages simultaneously: (1) lowering IL and widening bandwidth to emulate HPF functionality, and (2) introducing a low-side zero that improves low-side selectivity. These advantages carry over to cascaded BPF's incorporating a Z-coupled CES. An additional advantage of a cascaded BPF incorporating a Z-coupled CES is that some designs with certain element values enhance (deepen) high-side zeroes, thus improving high-side selectivity.

### Benefits

Benefits of the novel pseudo-HPF design include the ability to be used as a single BPF with moderate bandwidth, a reduction of the insertion loss that accompanies increased bandwidth, reduction of insertion loss due to skin effect (particularly at 100+ GHz), avoidance of narrow first pair and last pair inter-sectional gaps, existence of a low-side zero that helps with adjustment of selectivity, and combinability with a suitable LPF in a low-loss, wide bandwidth (≥an octave) cascaded BPF that generally will have more ultimate stopband rejection than a single BPF design.

While the example cascaded BPFs described above have focused on high frequencies (e.g., 100+ GHz), the inventive designs may also be used for lower frequency applications, as low as a few hundred MHz, requiring a high-attenuation stopband.

Communications and sensing applications that are envisioned to operate at frequencies at and above about 100 GHz, where vast continuous spectral bands may be available, are expected to benefit from cascaded BPFs in accordance with the present invention having wide bandwidth, low insertion loss, sufficient levels of attenuation, independent control of attenuation in low-side and high-side frequencies, and high selectivity.

As a person of ordinary skill in the art will understand, a system architecture may be beneficially impacted by the current invention in critical ways, including better range, better reception, lower power, longer battery life, and wider bandwidth.

### Circuit Embodiments

Circuits and devices in accordance with the present invention may be used alone or in combination with other components, circuits, and devices. Embodiments of the present invention may be fabricated as integrated circuits (ICs), which may be encased in IC packages and/or in modules for ease of handling, manufacture, and/or improved performance. In particular, IC embodiments of this invention are often used in modules in which one or more of such ICs are combined with other circuit components or blocks (e.g., filters, amplifiers, passive components, and possibly additional ICs) into one package. The ICs and/or modules are then typically combined with other components, often on a printed circuit board, to form part of an end-product such as a cellular telephone, laptop computer, or electronic tablet, or to form a higher-level module which may be used in a wide variety of products, such as vehicles, test equipment, medical devices, etc. Through various configurations of modules and assemblies, such ICs typically enable a mode of communication, often wireless communication.

As one example of further integration of embodiments of the present invention with other components, FIG. 24 is a top plan view of a substrate 2400 that may be, for example, a printed circuit board or chip module substrate (e.g., a thin-film tile). In the illustrated example, the substrate 2400 includes multiple ICs 2402a-2402d having terminal pads 2404 which would be interconnected by conductive vias and/or traces on and/or within the substrate 2400 or on the opposite (back) surface of the substrate 2400 (to avoid clutter, the surface conductive traces are not shown and not all terminal pads are labelled). The ICs 2402a-2402d may embody, for example, signal switches, active and/or passive filters, amplifiers (including one or more LNAs), and other circuitry. For example, IC 2402b may incorporate one or more instances of a cascaded BPF in accordance with the present invention.

The substrate 2400 may also include one or more passive devices 2404 embedded in, formed on, and/or affixed to the substrate 2400. While shown as generic rectangles, the passive devices 2404 may be, for example, filters, capacitors, inductors, transmission lines, resistors, antennae elements, transducers (including, for example, MEMS-based transducers, such as accelerometers, gyroscopes, microphones, pressure sensors, etc.), batteries, etc., interconnected by conductive traces on or in the substrate 2400 to other passive devices 2404 and/or the individual ICs 2402a-2402d.

The front or back surface of the substrate 2400 may be used as a location for the formation of other structures. For example, one or more antennae may be formed on or affixed to the front or back surface of the substrate 2400; one example of a front-surface antenna 2408 is shown, coupled to an IC die 2402b, which may include RF front-end circuitry. Thus, by including one or more antennae on the substrate 2400, a complete radio may be created.

### System Aspects

Embodiments of the present invention are useful in a wide variety of larger radio frequency (RF) circuits and systems for performing a range of functions, including (but not limited to) impedance matching circuits, RF power amplifiers, RF low-noise amplifiers (LNAs), phase shifters, attenuators, antenna beam-steering systems, charge pump devices, RF switches, etc. Such functions are useful in a variety of applications, such as radar systems (including phased array and automotive radar systems), radio systems (including cellular radio systems), and test equipment.

Radio system usage includes wireless RF systems (including base stations, relay stations, and hand-held transceivers) that use various technologies and protocols, including various types of orthogonal frequency-division multiplexing (“OFDM”), quadrature amplitude modulation (“QAM”), Code-Division Multiple Access (“CDMA”), Time-Division Multiple Access (“TDMA”), Wide Band Code Division Multiple Access (“W-CDMA”), Global System for Mobile Communications (“GSM”), Long Term Evolution (“LTE”), 4G, 5G, 6G, and WiFi (e.g., 802.11a, b, g, ac, ax, be) protocols, as well as other radio communication standards and protocols.

As an example of wireless RF system usage, FIG. 25 illustrates a prior art wireless communication environment 2500 comprising different wireless communication systems 2502 and 2504, and which may include one or more mobile wireless devices 2504. A wireless device 2504 may be a cellular phone, a wireless-enabled computer or tablet, or some other wireless communication unit or device. A wireless device 2504 may also be referred to as a mobile station, user equipment, an access terminal, or some other terminology known in the telecommunications industry.

A wireless device 2504 may be capable of communicating with multiple wireless communication systems 2502, 2504 using one or more of telecommunication protocols such as the protocols noted above. A wireless device 2504 also may be capable of communicating with one or more satellites 2508, such as navigation satellites (e.g., GPS) and/or telecommunication satellites. The wireless device 2504 may be equipped with multiple antennas, externally and/or internally, for operation on different frequencies and/or to provide diversity against deleterious path effects such as fading and multi-path interference.

The wireless communication system 2502 may be, for example, a CDMA-based system that includes one or more base station transceivers (BSTs) 2510 and at least one switching center (SC) 2512. Each BST 2510 provides over-the-air RF communication for wireless devices 2504 within its coverage area. The SC 2512 couples to one or more BSTs 2510 in the wireless system 2502 and provides coordination and control for those BSTs 2510.

The wireless communication system 2504 may be, for example, a TDMA-based system that includes one or more transceiver nodes 2514 and a network center (NC) 2514. Each transceiver node 2514 provides over-the-air RF communication for wireless devices 2504 within its coverage area. The NC 2514 couples to one or more transceiver nodes 2514 in the wireless system 2504 and provides coordination and control for those transceiver nodes 2514.

In general, each BST 2510 and transceiver node 2514 is a fixed station that provides communication coverage for wireless devices 2504, and may also be referred to as base stations or some other terminology known in the telecommunications industry. The SC 2512 and the NC 2514 are network entities that provide coordination and control for the base stations and may also be referred to by other terminologies known in the telecommunications industry.

An important aspect of any wireless system, including the systems shown in FIG. 25, is in the details of how the component elements of the system perform. FIG. 26 is a block diagram of a transceiver 2600 that might be used in a wireless device, such as a cellular telephone, and which may beneficially incorporate an embodiment of the present invention for improved performance. As illustrated, the transceiver 2600 includes a mix of RF analog circuitry for directly conveying and/or transforming signals on an RF signal path, non-RF analog circuity for operational needs outside of the RF signal path (e.g., for bias voltages and switching signals), and digital circuitry for control and user interface requirements. In this example, a receiver path Rx includes RF Front End (RFFE), Intermediate Frequency (IF) Block, Back-End, and Baseband sections (noting that in some implementations, the differentiation between sections may be different). The various illustrated sections and circuit elements may be embodied in one die or multiple IC dies. For example, the RF Front End in the illustrated example may include an RFFE module and a Mixing Block, which may be embodied in (or as part of) different IC dies or modules. The different dies and/or modules may be coupled by transmission lines TIN and TOUT (e.g., microstrips, co-planar waveguides, or an equivalent structure or circuit), either or both of which may have, for example, a 4022 impedance.

The receiver path Rx receives over-the-air RF signals through at least one antenna 2602 and a switching unit 2604, which may be implemented with active switching devices (e.g., field effect transistors or FETs) and/or with passive devices that implement frequency-domain multiplexing, such as a diplexer or duplexer. An RF filter 2606 passes desired received RF signals to at least one low noise amplifier (LNA) 2608a, the output of which is coupled from the RFFE Module to at least one LNA 2608b in the Mixing Block (through transmission line TIN in this example). The LNA(s) 2608b may provide buffering, input matching, and reverse isolation. In some embodiments, the LNA(s) 2608a and 2608b may be a single LNA.

The output of the LNA(s) 2608b is combined in a corresponding mixer 2610 with the output of a first local oscillator 2612 to produce an IF signal. The IF signal may be amplified by an IF amplifier 2614 and subjected to an IF filter 2616 before being applied to a demodulator 2618, which may be coupled to a second local oscillator 2620. The demodulated output of the demodulator 2618 is transformed to a digital signal by an analog-to-digital converter 2622 and provided to one or more system components 2624 (e.g., a video graphics circuit, a sound circuit, memory devices, etc.). The converted digital signal may represent, for example, video or still images, sounds, or symbols, such as text or other characters.

In the illustrated example, a transmitter path Tx includes Baseband, Back-End, IF Block, and RF Front End sections (again, in some implementations, the differentiation between sections may be different). Digital data from one or more system components 2624 is transformed to an analog signal by a digital-to-analog converter 2624, the output of which is applied to a modulator 2628, which also may be coupled to the second local oscillator 2620. The modulated output of the modulator 2628 may be subjected to an IF filter 2630 before being amplified by an IF amplifier 2632. The output of the IF amplifier 2632 is then combined in a mixer 2634 with the output of the first local oscillator 2612 to produce an RF signal. The RF signal may be amplified by a driver 2634, the output of which is coupled to a power amplifier (PA) 2638 (through transmission line Tour in this example). The amplified RF signal may be coupled to an RF filter 2640, the output of which is coupled to at least one antenna 2602 through the switching unit 2604.

One or more of the RF filters 2606, 2616, 2630, and/or 2640 may include one or more instances of the novel BPF described above.

The operation of the transceiver 2600 is controlled by a microprocessor 2642 in known fashion, which interacts with system control components 2644 (e.g., user interfaces, memory/storage devices, application programs, operating system software, power control, etc.). In addition, the transceiver 2600 will generally include other circuitry, such as bias circuitry 2644 (which may be distributed throughout the transceiver 2600 in proximity to transistor devices), electro-static discharge (ESD) protection circuits, testing circuits (not shown), factory programming interfaces (not shown), etc.

In modern transceivers, there are often more than one receiver path Rx and transmitter path Tx, for example, to accommodate multiple frequencies and/or signaling modalities. Further, as should be apparent to one of ordinary skill in the art, some components of the transceiver 2600 may be positioned in a different order (e.g., filters) or omitted. Other components can be (and often are) added, such as (by way of example only) additional filters, impedance matching networks, variable phase shifters/attenuators, power dividers, etc.

### Methods

Another aspect of the invention includes methods for making a printed interdigitated-line wideband bandpass filter approaching a high pass filter (i.e., pseudo-high-pass filter). For example, FIG. 27 is a process flow chart 2700 showing a first method for making a printed interdigitated-line wideband BPF (pseudo-high-pass filter). The method includes: fabricating a set of interdigitated resonator sections, each adjacent pair of interdigitated resonator sections being separated by an associated gap (Block 2702); and fabricating at least one coupling enhancement strip spaced above and/or below the associated gap separating an adjacent pair of interdigitated resonator sections in the set of interdigitated resonator sections (Block 2704).

FIG. 28 is a process flow chart 2800 showing a method for making a printed-line wideband cascaded BPF. The method includes: fabricating a printed-line low-pass filter (Block 2802); fabricating a pseudo-high-pass filter as a set of interdigitated resonator sections electrically coupled to the low-pass filter, each adjacent pair of interdigitated resonator sections being separated by an associated gap (Block 2804); and fabricating at least one coupling enhancement strip spaced above and/or below the associated gap separating an adjacent pair of interdigitated resonator sections in the set of interdigitated resonator sections (Block 2806).

FIG. 29 is a process flow chart 2900 showing a first method for making a printed interdigitated-line wideband BPF approaching a high-pass filter (i.e., a pseudo-high-pass filter). The method includes: fabricating a set of interdigitated resonator sections, each adjacent pair of interdigitated resonator sections being separated by an associated gap (Block 2902); fabricating at least one coupling enhancement strip spaced above and/or below the associated gap separating an adjacent pair of interdigitated resonator sections in the set of interdigitated resonator sections, wherein the at least one coupling enhancement strip is electrically floating (Block 2904); fabricating a first ground plane spaced from and underlying the set of interdigitated resonator sections and the at least one coupling enhancement strip, wherein the first ground plane is electrically connected to a first end of a first subset of the set of interdigitated resonator sections (Block 2906); and fabricating a second ground plane spaced from and overlaying the set of interdigitated resonator sections and the at least one coupling enhancement strip, wherein the second ground plane is electrically connected to a second end of a second subset of the set of interdigitated resonator sections (Block 2908).

FIG. 30 is a process flow chart 3000 showing a second method for making a printed-line cascaded BPF. The method includes: fabricating a printed-line low-pass filter (Block 3002); fabricating a pseudo-high-pass filter as a set of interdigitated resonator sections electrically coupled to the low-pass filter, each adjacent pair of interdigitated resonator sections being separated by an associated gap (Block 3004); fabricating at least one coupling enhancement strip spaced above and/or below the associated gap separating an adjacent pair of interdigitated resonator sections in the set of interdigitated resonator sections, wherein the at least one coupling enhancement strip is electrically floating (Block 3006); fabricating a first ground plane spaced from and underlying the set of interdigitated resonator sections and the at least one coupling enhancement strip, wherein the first ground plane is electrically connected to a first end of a first subset of the set of interdigitated resonator sections (Block 3008); and fabricating a second ground plane spaced from and overlaying the set of interdigitated resonator sections and the at least one coupling enhancement strip, wherein the second ground plane is electrically connected to a second end of a second subset of the set of interdigitated resonator sections (Block 3010).

Additional aspects of the above method may include one or more of the following: wherein the at least one coupling enhancement strip is electrically floating; wherein the at least one coupling enhancement strip is conductive; wherein the set of interdigitated sections are conductive lines printed on a substrate; connecting a first busbar electrically to first ends of a first subset of the set of interdigitated resonator sections, and a second busbar electrically to second ends of a second subset of the set of interdigitated resonator sections; wherein the low-pass filter is a printed commensurate-line low-pass filter; and/or wherein the low-pass filter is a printed-line stepped-impedance low-pass filter.

### Fabrication Technologies & Options

As used in this disclosure, the term “radio frequency” (RF) refers to a rate of oscillation in the range of about 3 kHz to about 300 GHz. This term also includes the frequencies used in wireless communication systems. An RF frequency may be the frequency of an electromagnetic wave or of an alternating voltage or current in a circuit.

With respect to the figures referenced in this disclosure, the dimensions for the various elements are not to scale; some dimensions may be greatly exaggerated vertically and/or horizontally for clarity or emphasis. In addition, references to orientations and directions (e.g., “top”, “bottom”, “above”, “below”, “lateral”, “vertical”, “horizontal”, etc.) are relative to the example drawings, and not necessarily absolute orientations or directions.

Various embodiments of the invention can be implemented to meet a wide variety of specifications. Unless otherwise noted above, selection of suitable component values is a matter of design choice. Various embodiments of the invention may be implemented in any suitable integrated circuit (IC) technology, or in hybrid or discrete circuit forms. Integrated circuit embodiments may be fabricated using any suitable substrates and processes, including but not limited to PCBs, standard bulk silicon, high-resistivity bulk CMOS, silicon-on-insulator (SOI), and silicon-on-sapphire (SOS) using 2-D, 2.5-D, and 3-D structures.

Component voltage, current, and power handling capabilities may be adapted as needed, for example, by adjusting device sizes, serially “stacking” components to withstand greater voltages, and/or using multiple components in parallel to handle greater currents. Additional circuit components may be added (for example, see FIG. 14) to enhance the capabilities of the disclosed circuits and/or to provide additional functionality without significantly altering the functionality of the disclosed circuits.

### Conclusion

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, and/or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

1. A bandpass filter including a printed interdigitated-line bandpass filter including at least one coupling enhancement strip.

2. The invention of claim 1, wherein the at least one coupling enhancement strip is electrically floating.

3. The invention of claim 1, wherein the at least one coupling enhancement strip is conductive.

4. The invention of claim 1, wherein the printed interdigitated-line bandpass filter includes a set of interdigitated resonator sections, each adjacent pair of interdigitated resonator sections being separated by an associated gap, and wherein the at least one coupling enhancement strip is spaced from an associated gap separating an adjacent pair of interdigitated resonator sections in the set of interdigitated resonator sections.

5. The invention of claim 4, wherein the set of interdigitated sections are conductive lines printed on a substrate.

6. The invention of claim 4, further including a first busbar electrically connecting first ends of a first subset of the set of interdigitated resonator sections, and a second busbar electrically connecting second ends of a second subset of the set of interdigitated resonator sections.

7. A bandpass filter including:
(a) a set of interdigitated resonator sections, each adjacent pair of interdigitated resonator sections being separated by an associated gap;
(b) a first signal port coupled to a first end interdigitated resonator section of the set of interdigitated resonator sections;
(c) a second signal port coupled to a second end interdigitated resonator section of the set of interdigitated resonator sections;
(d) at least one coupling enhancement strip spaced from the associated gap separating an adjacent pair of interdigitated resonator sections in the set of interdigitated resonator sections, wherein the at least one coupling enhancement strip is electrically floating;
(e) a first ground plane spaced from and underlying the at least two interdigitated resonator sections and the at least one coupling enhancement strip, wherein the first ground plane is electrically connected to a first end of a first subset of the set of interdigitated resonator sections; and
(f) a second ground plane spaced from and overlaying the at least two interdigitated resonator sections and the at least one coupling enhancement strip, wherein the second ground plane is electrically connected to a second end of a second subset of the set of interdigitated resonator sections.

8. The invention of claim 7, wherein the set of interdigitated sections are conductive lines printed on a substrate.

9. The invention of claim 7, wherein the at least one coupling enhancement strip comprises a conductive material.

10. The invention of claim 7, further including a first busbar electrically connecting the first ends of the first subset of the set of interdigitated resonator sections, and a second busbar electrically connecting the second ends of the second subset of the set of interdigitated resonator sections.

11.-14. (canceled)

15. A cascaded bandpass filter including:
(a) a low-pass filter; and
(b) a printed interdigitated-line bandpass filter including at least one coupling enhancement strip and electrically coupled to the low-pass filter.

16. The invention of claim 11, wherein the low-pass filter is a printed-line low-pass filter.

17. The invention of claim 11, wherein the low-pass filter is a printed commensurate-line low-pass filter.

18. The invention of claim 11, wherein the low-pass filter is a printed-line stepped-impedance low-pass filter.

19. The invention of claim 11, wherein the at least one coupling enhancement strip is electrically floating.

20. The invention of claim 11, wherein the at least one coupling enhancement strip is conductive.

21. The invention of claim 11, wherein the printed interdigitated-line bandpass filter includes a set of interdigitated resonator sections, each adjacent pair of interdigitated resonator sections being separated by an associated gap, and wherein the at least one coupling enhancement strip is spaced from an associated gap separating an adjacent pair of interdigitated resonator sections in the set of interdigitated resonator sections.

22. The invention of claim 21, wherein the set of interdigitated sections are conductive lines printed on a substrate.

23. The invention of claim 21, further including a first busbar electrically connecting first ends of a first subset of the set of interdigitated resonator sections, and a second busbar electrically connecting second ends of a second subset of the set of interdigitated resonator sections.

24.-61. (canceled)
